(19) United States
(12) Patent Application Publication
(10) Pub. No.: US 2026/0360983 A1
(43) Pub. Date: Nov. 12, 2026

(54) PATCH ANTENNA AND ANTENNA DEVICE

(71) Applicant: YOKOWO CO., LTD., Tokyo (JP)

(72) Inventors: Hiroto IEDA, Tomioka-Shi, Gunma (JP); Kazuhiro KOWAITA, Tomioka-Shi, Gunma (JP)

(73) Assignee: YOKOWO CO., LTD., Tokyo (JP)

(21) Appl. No.: 19/103,078

(22) PCT Filed: Aug. 10, 2023
(86) PCT No.: PCT/JP2023/029350

§ 371 Date: Feb. 11, 2025

(30) Foreign Application Priority Data
Aug. 12, 2022 (JP) 2022-129016
Aug. 12, 2022 (JP) 2022-129017

(51) Int. Cl. H01Q 9/04; H01Q 5/35; H01Q 5/357; H01Q 13/08; H01Q 21/28; H01Q 21/30

(52) U.S. Cl. CPC H01Q 9/0407; H01Q 5/35; H01Q 5/357; H01Q 21/28; H01Q 13/08; H01Q 21/30

(57) ABSTRACT

A patch antenna comprising: a first feeding portion; a second feeding portion; and a radiating element in a substantially quadrilateral shape, wherein when seen in a direction of a normal to the radiating element, the first feeding portion is located on a first diagonal line of the radiating element, and the second feeding portion is located on a second diagonal line of the radiating element. A patch antenna comprising: a first feeding portion; a second feeding portion; a dielectric in a substantially quadrilateral shape; and a radiating element arranged at the dielectric, wherein when seen in a direction of a normal to the radiating element, the first feeding portion is located on a first diagonal line of the dielectric, and the second feeding portion is located on a second diagonal line of the dielectric.

### TECHNICAL FIELD

The present disclosure relates to a patch antenna and an antenna device.

### BACKGROUND ART

Patent Literature 1 discloses a patch antenna including two feeding portions that are arranged such that the phase difference is 90 degrees in circularly polarized waves.

### CITATION LIST

### Patent Literature

[PTL 1] Japanese Patent No. JP6624020

### SUMMARY OF INVENTION

### Technical Problem

In the patch antenna described in Patent Literature 1, there was a limit to the distance that can be provided between the two feeding portions, which makes it difficult to ensure isolation.

The present disclosure is directed to, for example, easily ensuring isolation between a plurality of feeding portions. The present disclosure is directed also to others that will become apparent from the present description herein.

### Solution to Problem

An aspect of the present disclosure is a patch antenna comprising: a first feeding portion; a second feeding portion; and a radiating element in a substantially quadrilateral shape, wherein when seen in a direction of a normal to the radiating element, the first feeding portion is located d on a first diagonal line of the radiating element, and the second feeding portion is located on a second diagonal line of the radiating element.

Another aspect of the present disclosure is a patch antenna comprising: a first feeding portion; a second feeding portion; a dielectric in a substantially quadrilateral shape; and a radiating element arranged at the dielectric, wherein when seen in a direction of a normal to the radiating element, the first feeding portion is located on a first diagonal line of the dielectric, and the second feeding portion is located on a second diagonal line of the dielectric.

According to an aspect described above of the present disclosure, it is possible to easily ensure isolation between a plurality of feeding portions.

### BRIEF DESCRIPTION OF DRAWINGS

FIG. 1 is a plan view of a patch antenna 10 according to a first embodiment.

FIG. 2 is a perspective view of a patch antenna 10 according to a first embodiment.

FIG. 3A is a plan view of a patch antenna 10X according to a first comparative example.

FIG. 3B is a plan view of a patch antenna 10Y according to a second comparative example.

FIG. 3C is a plan view of a patch antenna 10Z according to a third comparative example.

FIG. 4A is a graph illustrating an example of frequency characteristics of a patch antenna 10X, a patch antenna 10Y, and a patch antenna 10Z.

FIG. 4B is a graph illustrating an example of frequency characteristics of a patch antenna 10.

FIG. 5A is a table illustrating widths GP in a patch antenna 10.

FIG. 5B is a graph illustrating an example of results when a width GP is changed.

FIG. 6A is a perspective view of a patch antenna 10A according to a first modification example.

FIG. 6B is a perspective view of a patch antenna 10B according to a second modification example.

FIG. 7 is a plan view of a patch antenna 10C according to a third modification example.

FIG. 8A is a perspective view of a patch antenna 10D according to a fourth modification example.

FIG. 8B is a perspective view of a patch antenna 10E according to a fifth modification example.

FIG. 9A is a plan view of a patch antenna 10F according to a sixth modification example.

FIG. 9B is a plan view of a patch antenna 10G according to a seventh modification example.

FIG. 9C is a plan view of a patch antenna 10H according to an eighth modification example.

FIG. 10A is a perspective view of a patch antenna 10I according to a ninth modification example.

FIG. 10B is a perspective view of a patch antenna 10J according to a tenth modification example.

FIG. 11A is a perspective view illustrating a state before fitting feeding portions 15 into a dielectric 14, with respect to a first example of a procedure of assembling a patch antenna 10.

FIG. 11B is a perspective view illustrating a state after fitting feeding portions 15 into a dielectric 14, with respect to a first example of a procedure of assembling a patch antenna 10.

FIG. 12 is an enlarged perspective view of a pinhole 36 in a dielectric 14 and its vicinity.

FIG. 13A is a perspective view illustrating a state before fitting feeding portions 15 into a dielectric 14, with respect to a second example of a procedure of assembling a patch antenna 10.

FIG. 13B is a perspective view illustrating a state after fitting feeding portions 15 into a dielectric 14, with respect to a second example of a procedure of assembling a patch antenna 10.

FIG. 13C is an explanatory diagram illustrating a state before inserting the feeding portion 15 into a pinhole 36, in a first example of a method of fixing a dielectric 14 and a feeding portion 15 to each other.

FIG. 13D is an explanatory diagram illustrating, in a first example of a method of fixing a dielectric 14 and a feeding portion 15 to each other, a state after inserting the feeding portion 15 into a pinhole 36.

FIG. 13E is an explanatory diagram illustrating, in a first example of a method of fixing a dielectric 14 and a feeding portion 15 to each other, a state of fixing the feeding portion 15 and the dielectric 14 to each other.

FIG. 13F is an explanatory diagram illustrating, in a second example of a method of fixing a dielectric 14 and a feeding portion 15 to each other, a state before inserting the feeding portion 15 into a pinhole 36.

FIG. 13G is an explanatory diagram illustrating, in a second example of a method of fixing a dielectric 14 and a feeding portion 15 to each other, a state after inserting the feeding portion 15 into a pinhole 36.

FIG. 13H is an explanatory diagram illustrating, in a second example of a method of fixing a dielectric 14 and a feeding portion 15 to each other, a state of fixing the feeding portion 15 and the dielectric 14 to each other.

FIG. 14A is an example of a current distribution diagram in a patch antenna 10H.

FIG. 14B is another example of a current distribution diagram in a patch antenna 10H.

FIG. 15A is a first example of a circuit diagram of a patch antenna 10.

FIG. 15B is a second example of a circuit diagram of a patch antenna 10.

FIG. 15C is a third example of a circuit diagram of a patch antenna 10.

FIG. 16 is an exploded perspective view of an antenna device 100 according to a first embodiment.

FIG. 17 is a plan view of a patch antenna 20 according to a second embodiment.

FIG. 18 is a plan view of a patch antenna 20X according to a comparative example.

FIG. 19 is a plan view of a patch antenna 20A according to a modification example.

FIG. 20 is a plan view of an antenna device 200 according to a second embodiment.

FIG. 21A is a plan view of an antenna device 200X according to a first comparative example.

FIG. 21B is a plan view of an antenna device 200Y according to a second comparative example.

### DESCRIPTION OF EMBODIMENTS

At least the following matters will become apparent from the present description and the accompanying drawings.

Hereinafter, preferred embodiments of the present disclosure will be described with reference to the drawings. The same or equivalent components, members, and the like illustrated in the drawings are given the same reference signs, and overlapping description thereof will be omitted as appropriate.

### First Embodiment

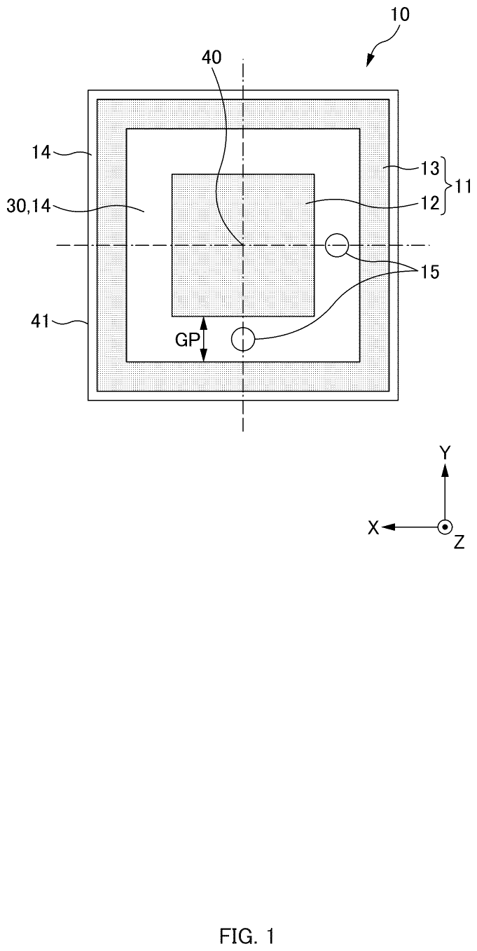

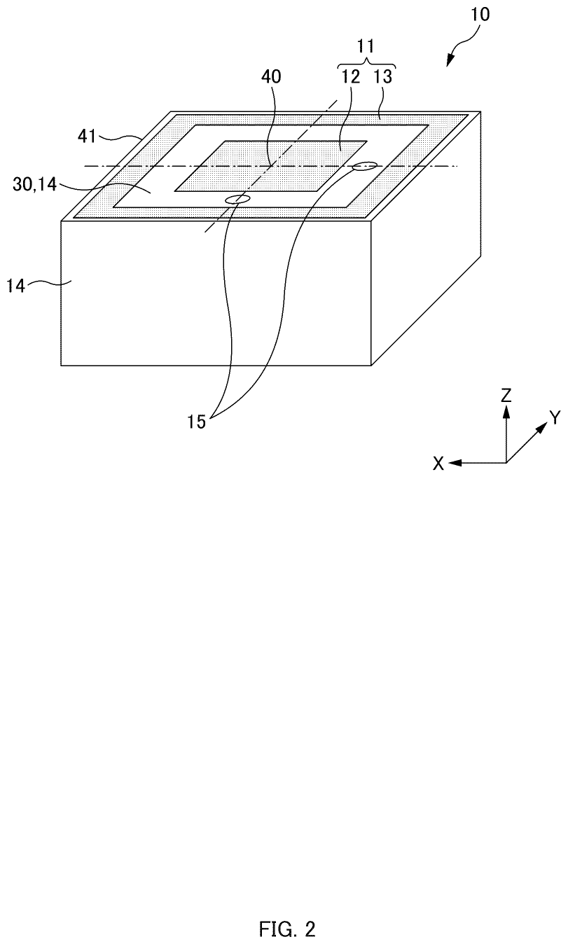

FIG. 1 is a plan view of a patch antenna 10 according to a first embodiment. FIG. 2 is a perspective view of the patch antenna 10 according to the first embodiment.

### Definition of Directions and the Like

First, with reference to FIGS. 1 and 2, directions and the like (X direction, Y direction, and Z direction) in the patch antenna 10 are defined.

Directions that are parallel to a front surface of a first radiating element 12 (described below) of the patch antenna 10 and that are orthogonal to each other are defined as a “+X direction” and a “+Y direction”. In the patch antenna 10 of an embodiment of the present disclosure, as illustrated in FIGS. 1 and 2, each of the +X direction and +Y direction is also a direction from one feeding portion 15 (described below) toward the center 40 of the patch antenna 10. As illustrated in FIGS. 1 and 2, the direction of the normal to the front surface of the first radiating element 12 is defined as a “+Z direction”.

A direction opposite to the +X direction is defined as a “−X direction”. Simply a “X direction” may be used for the case of indicating both of the +X direction and the −X direction or the case of representing either one of the +X direction or the −X direction. A “−Y direction” and a “Y direction” with respect to the +Y direction and a “−Z direction” and a “Z direction” with respect to the +Z direction are defined similarly to the −X direction and the X direction with respect to the +X direction.

Here, the “front surface” of the first radiating element 12 refers to, when the first radiating element 12 is arranged at a dielectric 14 as will be described below, a surface opposite to a surface on the dielectric 14 side out of the surfaces of the first radiating element 12. Further, the “front surface” of the first radiating element 12 refers to, when the first radiating element 12 is formed of a conductive pattern in a substrate, as will be described below, a surface on the side on which the conductive pattern is formed in the substrate.

The “center 40” of the patch antenna 10 refers to the geometric center of the shape of the outer edge of the patch antenna 10 (here, the shape of the outer edge of the dielectric 14, which will be described below), in plan view as illustrated in FIG. 1. Here, an “outer edge part 41” of the patch antenna 10 refers to a region including the outer edge of the patch antenna 10 (here, the outer edge of the dielectric 14), in the plan view. Here, “plan view” refers to a plan view with respect to the front surface of the first radiating element 12, specifically, a way of viewing the patch antenna 10 in the −Z direction.

As is apparent from being defined as the +Z direction, the “direction of the normal to the front surface” of the first radiating element 12 refers to a direction that is perpendicular to the front surface of the first radiating element 12 and is the direction from the surface on the −Z direction side (hereinafter, which may be referred to as “back surface”) toward surface (front surface) on the +Z direction side. In other words, the “direction of the normal to the front surface” of the first radiating element 12 does not refer to both of the direction from the back surface toward the front surface and the direction from the front surface toward the back surface of the first radiating element 12, but refers to the direction determined as to its orientation.

In FIGS. 1 and 2, in order to facilitate understanding of the directions and the like of the patch antenna 10, each of the +X direction, +Y direction, and +Z direction is indicated by an arrowed line segment. However, the intersection of these arrowed line segments does not indicate the origin of coordinates.

The patch antenna 10 of an embodiment of the present disclosure is arranged with the +Z direction being the zenith direction. Thus, in the following description, the +Z direction may be referred to as “zenith direction” or “upward direction” and the −Z direction may be referred to as “downward direction”. A direction parallel to an X-Y plane (i.e., a direction parallel to the front surface of the first radiating element 12) may be referred to as “lateral direction” and the Z direction may be referred to as “vertical direction” or “height direction”.

The above-described definitions of directions and the like are also common to the other embodiments in the present description unless otherwise specified.

### Overview of Patch Antenna 10

Next, an overview of the patch antenna 10 of an embodiment of the present disclosure will be described with reference again to FIGS. 1 and 2 described above.

The patch antenna 10 is a planar antenna, and supports radio waves in a frequency band for a global navigation satellite system (GNSS), for example. The patch antenna 10 of an embodiment of the present disclosure is a so-called multi-band antenna that supports radio waves in a plurality of frequency bands. Specifically, the patch antenna 10 of an embodiment of the present disclosure supports radio waves in two frequency bands, which are an L1 band (1559 MHz to 1610 MHz band) and an L5 band (1164 MHz to 1214 MHz band).

A frequency band of radio waves supported by the patch antenna 10 may be a frequency band other than the combination of the two frequency bands, which are the L1 band and the L5 band. For example, a frequency band of radio waves supported by the patch antenna 10 may be a combination of two frequency bands, which are the L1 band and an L2 band (1212 MHz to 1254 MHz band) or may be a combination of three frequency bands, which are the L1 band, the L2 band, and the L5 band.

Here, in each of the L1 band, the L2 band, and the L5 band, the center frequency is a frequency to be targeted in the patch antenna 10 of an embodiment of the present disclosure. The center frequency of the L1 band is 1575.42 MHz, the center frequency of the L2 band is 1227.60 MHz, and the center frequency of the L5 band is 1176.45 MHz. In the patch antenna 10, the shape of each of the first radiating element 12 and the second radiating element 13, which will be described below, is designed based on the frequency to be targeted.

Moreover, a frequency band of radio waves supported by the patch antenna 10 may include an L band (1525 MHz to 1559 MHz band) and/or an L6 band (1273 MHz to 1284 MHz band) obtained by further combining a correction satellite signal, in addition to the L1 band, the L2 band, and the L5 band. A frequency band of radio waves supported by the patch antenna 10 is not limited to the above-described combinations of the plurality of specific frequency bands, but may be a combination of a plurality of given frequency bands. The patch antenna 10 may support radio waves in one frequency band only.

A communication standard and frequency band of radio waves supported by the patch antenna 10 are not limited to the GNSS, but may be another communication standard and frequency band. For example, the patch antenna 10 may support radio waves in a frequency band for a satellite digital audio radio service (SDARS) or radio waves in a frequency band for Vehicle to Everything (V2X: vehicle-to-vehicle communication, road-to-vehicle communication).

The patch antenna 10 includes the first radiating element 12, the second radiating element 13, the dielectric 14, and the feeding portion 15. In the following description, the first radiating element 12 and the second radiating element 13 may be collectively referred to as “radiating element 11”.

The radiating element 11 is a conductive member arranged at the dielectric 14. The shape of the outer edge of the radiating element 11 (here, the shape of the outer edge of the second radiating element 13, which will be described below) is a shape of a substantially quadrilateral (hereinafter, may be referred to as “substantially quadrilateral shape”), in plan view as illustrated in FIG. 1. As will be described below, the shape of the outer edge of the dielectric 14 is also a substantially quadrilateral shape. The substantially quadrilateral shape formed by the shape of the outer edge of the radiating element 11 is smaller than the substantially quadrilateral shape formed by the shape of the outer edge of the dielectric 14. Here, the “quadrilateral shape” refers to a shape consisting of four sides, including, for example, a square, a rectangle, a trapezoid, a parallelogram, and like. The “substantially quadrilateral shape” may have at least a part of the corners cut off at an angle relative to a side thereof, for example. Moreover, in the “substantially quadrilateral shape”, a part of the sides may have a cutout (recessed part) or a protrusion (protruding part).

In the patch antenna 10 of an embodiment of the present disclosure, the shape of the outer edge of the radiating element 11 is, as illustrated in FIG. 1, a substantially square shape with the vertical length equal to the lateral length (hereinafter, may be referred to as “substantially square shape”). The shape of the outer edge of the radiating element 11 may be a substantially rectangular shape with the vertical length different from the lateral length (hereinafter, may be referred to as “substantially rectangular shape”). The “substantially square shape” and the “substantially rectangular shape” are included in the “substantially quadrilateral shape” described above.

The shape of the outer edge of the radiating element 11 is not limited to the substantially quadrilateral shape, but may be, for example, a shape such as a circular shape, an elliptical shape, a polygonal shape, or the like. The shape of the outer edge of the radiating element 11 only has to be a shape capable of supporting radio waves in a desired frequency band (here, the L1 band and the L5 band for GNSS).

The first radiating element 12 is a member located on the inner side in the radiating element 11, and the second radiating element 13 is a member located on the outer side in the radiating element 11. Here, the “inner side” is a side closer to the center 40 in a surface of the patch antenna 10. The “outer side” is a side away from the center 40 in the surface of the patch antenna 10. Here, the surface of the patch antenna 10 refers to a surface (e.g., upper surface or side surface) of the radiating element 11 or the dielectric 14.

In the patch antenna 10 of an embodiment of the present disclosure, as illustrated in FIG. 1, the entire first radiating element 12 is located on the inner side relative to the entire second radiating element 13. In other words, the entire second radiating element 13 is located on the outer side relative to the entire first radiating element 12. However, a part of the first radiating element 12 may be located on the outer side relative to the second radiating element 13.

In the patch antenna 10 of an embodiment of the present disclosure, the second radiating element 13 is located so as to surround the first radiating element 12, as illustrated in FIGS. 1 and 2. Specifically, the second radiating element 13 surrounds the first radiating element 12 with a space (slot region 30, which will be described below) from the outer edge of the first radiating element 12. More specifically, in plan view as illustrated in FIG. 1, the shape of the outer edge of the first radiating element 12 is a substantially square shape and the second radiating element 13 is provided along the sides of a substantially square shape larger than the shape of the outer edge (substantially square shape) of the first radiating element 12. The shape of the outer edge of the second radiating element 13 is a substantially square shape.

As described above, in the patch antenna 10 of an embodiment of the present disclosure, both the shape of the outer edge of the first radiating element 12 and the shape of the outer edge of the second radiating element 13 are substantially square shapes. However, the shape of the outer edge of the first radiating element 12 may be different from the shape of the outer edge of the second radiating element 13. The second radiating element 13 only has to be located so as to surround the first radiating element 12, and for example, the shape of the outer edge of the first radiating element 12 may be a substantially square shape, and the shape of the outer edge of the second radiating element 13 may have a substantially rectangular shape or circular shape.

Moreover, the second radiating element 13 is not limited to an aspect in which the second radiating element 13 surrounds the entire outer circumference of the first radiating element 12, but the surrounding shape of the second radiating element 13 may have a cutout part. From the cutout part of the surrounding shape of the second radiating element 13, the first radiating element 12 may protrude to the outside of the second radiating element 13.

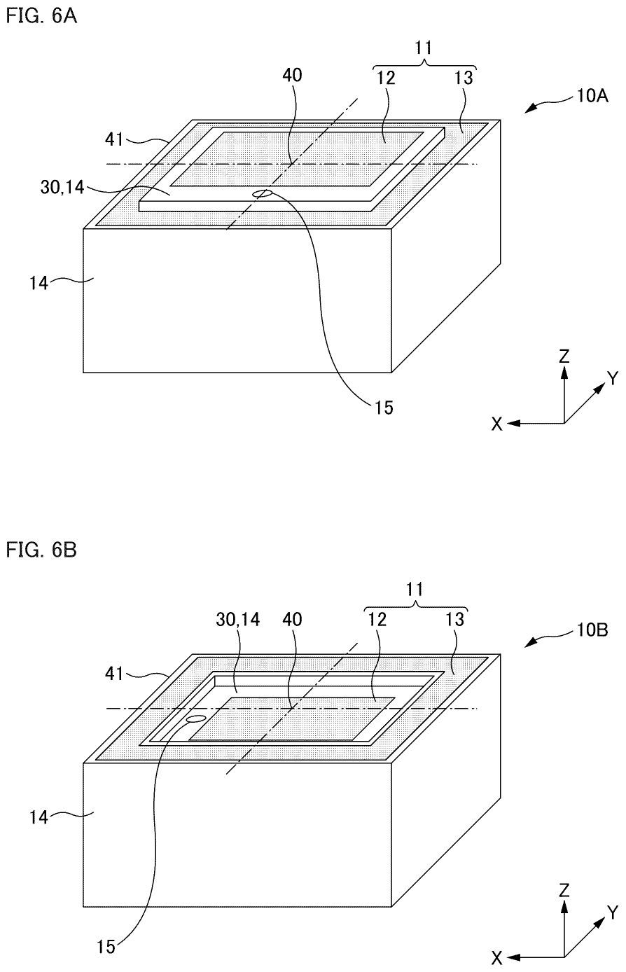

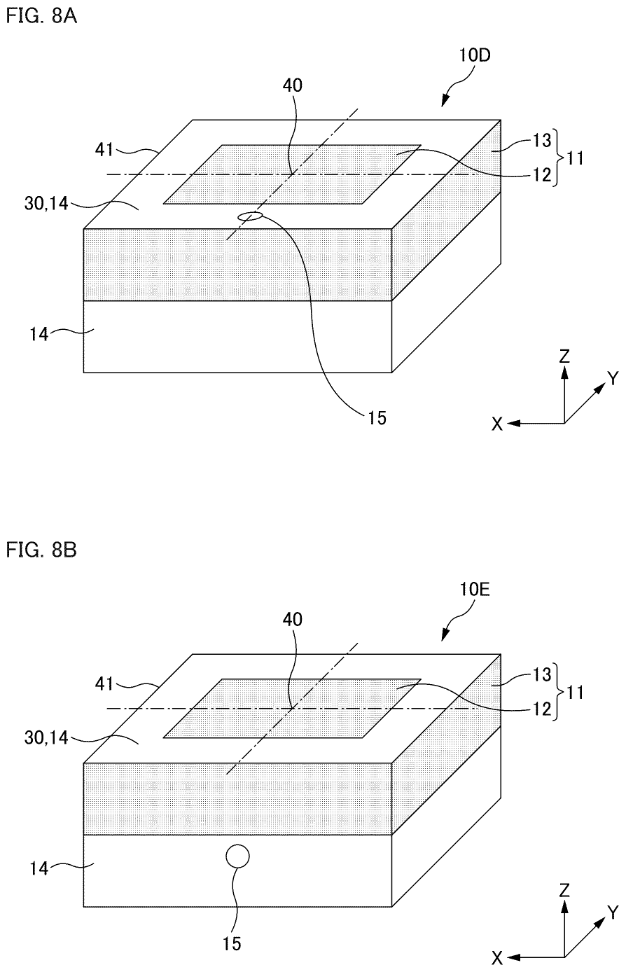

Each of the first radiating element 12 and the second radiating element 13 is arranged at the dielectric 14. In the patch antenna 10 of an embodiment of the present disclosure, the first radiating element 12 and the second radiating element 13 are arranged at one surface of the dielectric 14 (here, the top surface of the dielectric 14), as illustrated in FIGS. 1 and 2. However, an aspect is not limited to one in which the first radiating element 12 and the second radiating element 13 are arranged at one surface of the dielectric 14, but the first radiating element 12 and the second radiating element 13 may be arranged at the different surfaces of the dielectric 14, respectively. The details will be described in a patch antenna 10A of a first modification example illustrated in FIG. 6A, a patch antenna 10B of a second modification example illustrated in FIG. 6B, a patch antenna 10D of a fourth modification example illustrated in FIG. 8A, and a patch antenna 10E of a fifth modification example illustrated in FIG. 8B, which will be described below.

Each of the first radiating element 12 and the second radiating element 13 may be arranged over two or more surfaces of the dielectric 14, without being arranged at only one surface of the dielectric 14. Although not illustrated, for example, at least one of the first radiating element 12 or the second radiating element 13 may be arranged over two surfaces that are the top surface and the side surface of the dielectric 14.

Each of the first radiating element 12 and the second radiating element 13 may be formed of a conductive pattern in a substrate.

In the patch antenna 10 of an embodiment of the present disclosure, as illustrated in FIGS. 1 and 2, the slot region 30 is formed between the first radiating element 12 and the second radiating element 13. The slot region 30 is a region sandwiched between the first radiating element 12 and the second radiating element 13. As described above, the first radiating element 12 and the second radiating element 13 are arranged at the dielectric 14, and thus in the slot region 30, the dielectric 14 is exposed.

In the patch antenna 10 of an embodiment of the present disclosure, as illustrated in FIGS. 1 and 2, the slot region 30 is formed, at the surrounding of the first radiating element 12, along the sides of the substantially square shape of the first radiating element 12. However, the slot region 30 is not limited to an aspect illustrated in FIGS. 1 and 2, but may have at least a part that is formed in a meander shape, a serpentine shape, a curved shape, an arc shape, a zigzag shape, or a spiral shape or may have a shape obtained by combining these.

The first radiating element 12 and the second radiating element 13 are arranged so as to electrically coupled to each other. Accordingly, a width GP (see FIG. 1) of the slot region 30 that is sandwiched between the first radiating element 12 and the second radiating element 13 is set in a range in which the first radiating element 12 and the second radiating element 13 are electrically coupled to each other. Here, the “width GP” of the slot region 30 is, in a direction from the inner side toward the outer side of the patch antenna 10 (or in a direction from the outer side toward the inner side of the patch antenna 10), the minimum distance from an outer end of the first radiating element 12 to an inner end of the second radiating element 13.

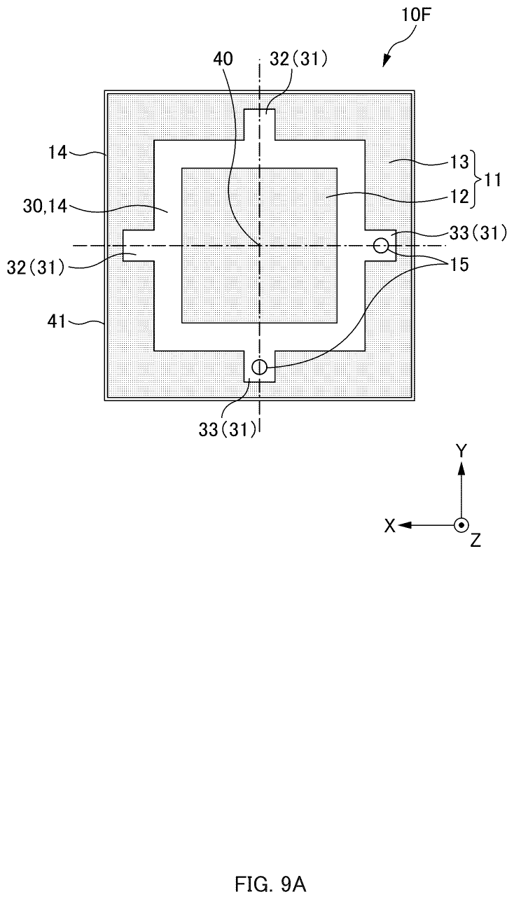

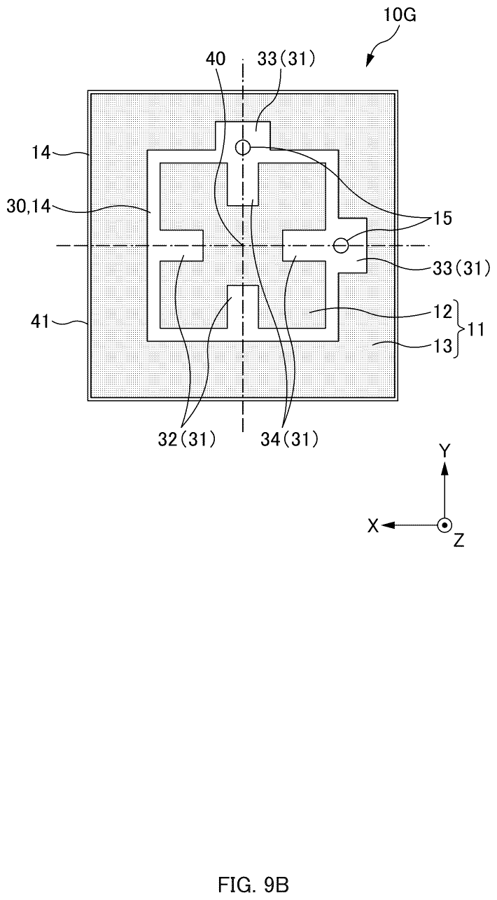

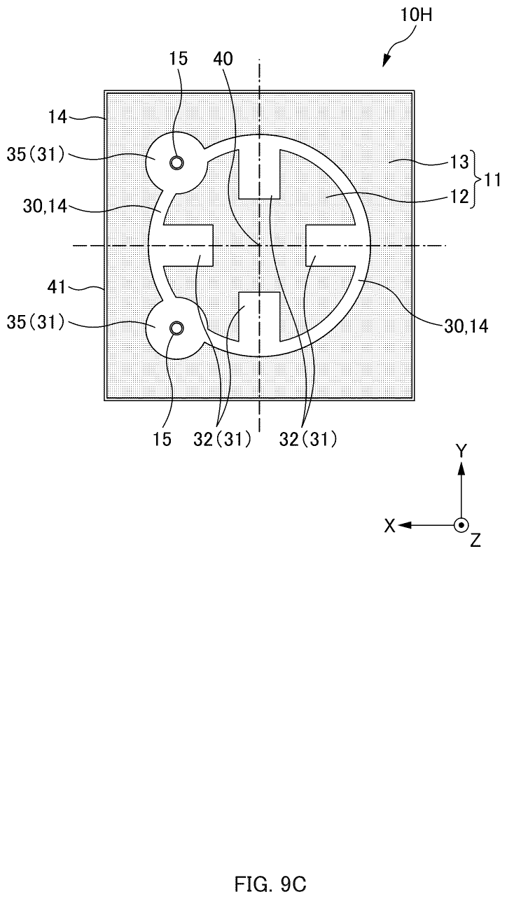

In the patch antenna 10 of an embodiment of the present disclosure, as illustrated in FIG. 1, the width GP of the slot region 30 is equal all around the first radiating element 12. However, the width GP of the slot region 30 does not have to be equal all around the first radiating element 12. For example, a patch antenna 10F illustrated in FIG. 9A, which will be described below, may have a cutout part 31, thereby including a part with the width GP larger than that in other part.

In the patch antenna 10 of an embodiment of the present disclosure, the first radiating element 12 supports radio waves in the L1 band for GNSS, and the second radiating element 13 supports radio waves in the L5 band for GNSS. In other words, the first radiating element 12 has a shape to support desired radio waves in the L1 band, and the second radiating element 13 has a shape to support desired radio waves in the L5 band. According to the shape of each of the first radiating element 12 and the second radiating element 13, the shape of the slot region 30 is determined as appropriate. The first radiating element 12 may support radio waves in the L5 band for GNSS and the second radiating element 13 may support radio waves in the L1 band for GNSS.

The dielectric 14 is a member made of a dielectric material such as ceramics. The dielectric 14 has a substantially quadrilateral shape in plan view. In the patch antenna 10 of an embodiment of the present disclosure, as illustrated in FIGS. 1 and 2, the first radiating element 12 and the second radiating element 13 are arranged at the dielectric 14. Although not illustrated, a conductive pattern that functions as a ground conductor film (or ground conductor plate) is provided at the back surface of the dielectric 14. The shape of the dielectric 14 is not limited to the substantially quadrilateral shape but may be, for example, a shape such as a circular shape, an elliptical shape, or a polygonal shape. The dielectric 14 may be a dielectric substrate or may be a solid or hollow member made of resin.

The feeding portion 15 is a conductive member including a feeding point. The feeding point is a part at which a feed line (not illustrated) feeds the first radiating element 12 and the second radiating element 13. The patch antenna 10 of an embodiment of the present disclosure employs a configuration including two feed lines for feeding the first radiating element 12 and the second radiating element 13, in other words, a double-feed system. Thus, the patch antenna 10 of an embodiment of the present disclosure includes two feeding portions 15, as illustrated in FIGS. 1 and 2.

However, the feed system in the patch antenna 10 is not limited to the double-feed system. In the patch antenna 10, for example, a quadruple-feed system may be employed. The patch antenna 10 employing the quadruple-feed system includes four feeding portions 15. In the patch antenna 10, for example, a single-feed system may be employed. The patch antenna 10 employing the single-feed system includes one feeding portion 15.

In the patch antenna 10 of an embodiment of the present disclosure, at least one feeding portion 15 is arranged in a region other than the radiating element 11 (the first radiating element 12 and the second radiating element 13). Specifically, the feeding portion 15 is, as illustrated in FIGS. 1 and 2, located at the dielectric 14, between the first radiating element 12 and the second radiating element 13 (i.e., in the slot region 30). The feeding portion 15 is arranged so as to be electrically coupled to the first radiating element 12 and the second radiating element 13. This enables the feeding portion 15 to feed the first radiating element 12 and the second radiating element 13.

The positions of the two feeding portions 15 illustrated in FIGS. 1 and 2 are examples. The positions of the feeding portions 15 only need to be at suitable positions such that the first radiating element 12 and the second radiating element 13 can support radio waves in desired frequency bands (here, the L1 band and L5 band for GNSS).

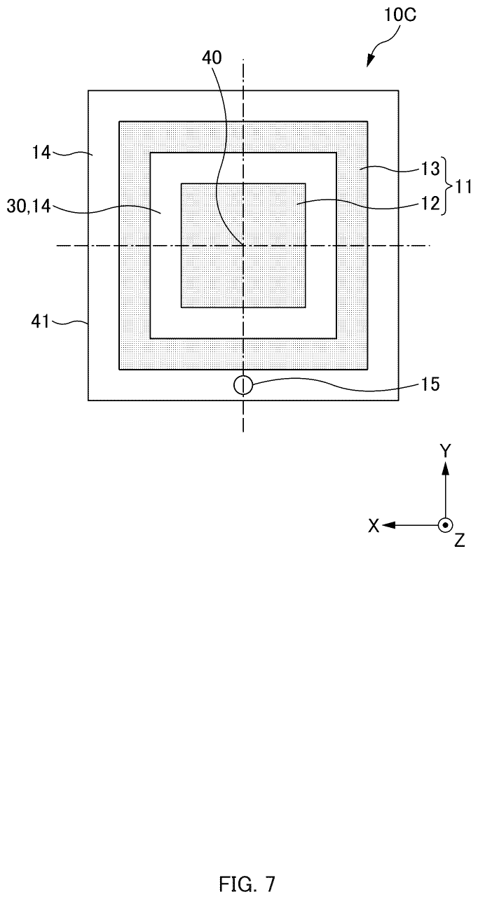

As described above, the patch antenna 10 of an embodiment of the present disclosure includes two feeding portions 15 located at the dielectric 14 in the slot region 30, as illustrated in FIGS. 1 and 2. However, out of the two feeding portions 15, one may be located at the dielectric 14 in the slot region 30, and the other one may be located at the first radiating element 12 or the second radiating element 13. In other words, at least one feeding portion 15 is to be arranged in a region other than the radiating element 11 (the first radiating element 12 and the second radiating element 13). In this event, the at least one feeding portion 15 may be located at the dielectric 14 in a region other than the slot region 30, as in a patch antenna 10C of a third modification example illustrated in FIG. 7, which will be be described below or the patch antenna 10E of the fifth modification example illustrated in FIG. 8B.

### Patch Antennas 10X to 10Z of Comparative Examples

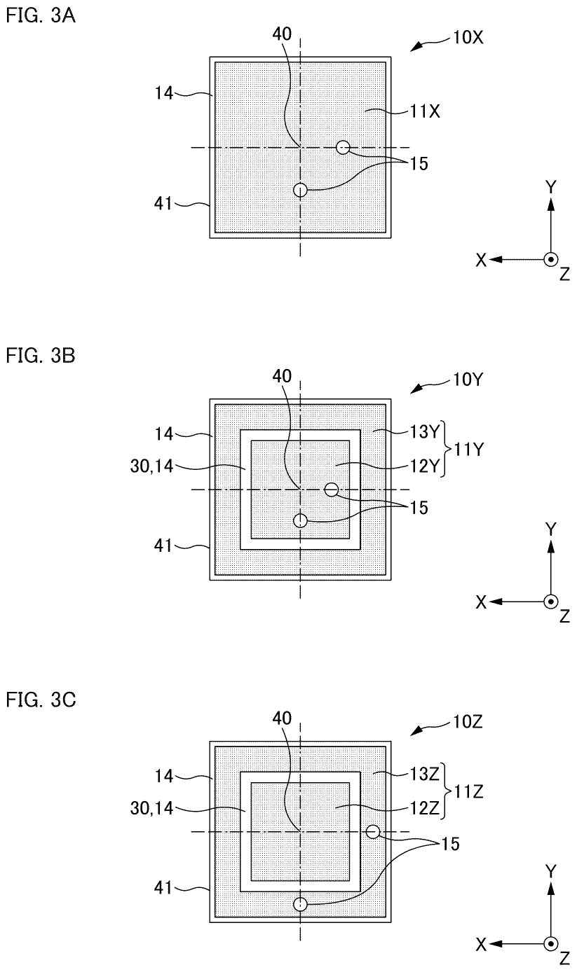

Next, features of the patch antenna 10 of an embodiment of the present disclosure will be further described, with reference to patch antennas 10X to 10Z of comparative examples illustrated in FIGS. 3A to 3C.

FIG. 3A is a plan view of the patch antenna 10X according to a first comparative example. FIG. 3B is a plan view of the patch antenna 10Y according to a second comparative example. FIG. 3C is a plan view of the patch antenna 10Z according to a third comparative example.

The patch antenna 10X of the first comparative example illustrated in FIG. 3A is different from the patch antenna 10 of an embodiment of the present disclosure described above in that a radiating element 11X supports radio waves in one frequency band only. The patch antenna 10X includes only one radiating element, without including such two radiating elements as the first radiating element 12 and the second radiating element 13 of the patch antenna 10 in an embodiment of the present disclosure.

Here, examples of an antenna device supporting multi-band include a so-called antenna device of a stacked patch antenna type in which a plurality of patch antennas supporting radio waves in frequency bands different from each other are stacked. Accordingly, even with such a patch antenna supporting only radio waves in one frequency band as in the patch antenna 10X of the first comparative example, it is possible to configure an antenna device supporting multiple bands by further stacking a patch antenna supporting radio waves in a frequency band different from that of the patch antenna 10X.

In a patch antenna of a double-feed system, however, particularly when a hybrid circuit part is needed, stacked patch antennas need to operate individually and thus need two or more hybrid circuit parts, resulting in the entire antenna device having a complicated configuration. Furthermore, with the patch antennas being stacked, the height of the entire antenna device is increased.

In contrast, the patch antenna 10 of an embodiment of the present disclosure has a configuration in which two radiating elements of the first radiating element 12 supporting the L1 band for GNSS and the second radiating element 13 supporting the L5 band for GNSS, are arranged at one single dielectric 14, and thus supports radio waves in a plurality of frequency bands. This makes it possible to simplify the configuration of the entire antenna device including the patch antenna 10. Moreover, it is not needed to stack the patch antennas 10 to support radio waves in a plurality of frequency bands, thereby being able to reduce the height of the entire antenna device. In the patch antenna 10 of an embodiment of the present disclosure, even when a hybrid circuit part is needed, one single hybrid circuit part is to be arranged, thereby being able to simplify the configuration of the entire antenna device, and furthermore reduce the number of parts.

The patch antenna 10Y of the second comparative example illustrated in FIG. 3B includes, as in the patch antenna 10 of an embodiment of the present disclosure described above, two radiating elements of a first radiating element 12Y and a second radiating element 13Y. In the patch antenna 10Y, for example, the first radiating element 12Y supports radio waves in the L1 band for GNSS and the second radiating element 13Y supports radio waves in the L5 band for GNSS. Accordingly, in contrast to the patch antenna 10X of the first comparative example described above, it is possible to simplify the configuration of the entire antenna device including the patch antenna 10Y, without needing an antenna device of the stacked patch antenna type. The patch antenna 10Y of the second comparative example, however, is different from the patch antenna 10 of an embodiment of the present disclosure described above in that all of the two feeding portions 15 are arranged at the first radiating element 12Y.

The patch antenna 10Y is different from the patch antenna 10 of an embodiment of the present disclosure in that each of the two feeding portions 15 directly feeds the first radiating element 12Y. And, the second radiating element 13Y is electrically coupled to the first radiating element 12Y. Accordingly, with the first radiating element 12Y and the second radiating element 13Y, the patch antenna 10Y is able to operate so as to support radio waves in a plurality of frequency bands.

The patch antenna 10Z of the third comparative example illustrated in FIG. 3C also includes, as in the patch antenna 10Y of the second comparative example described above, two radiating elements of a first radiating element 12Z supporting radio waves in the L1 band for GNSS and a second radiating element 13Z supporting radio waves in the L5 band for GNSS. Accordingly, in contrast to the patch antenna 10X of the first comparative example described above, the patch antenna 10Z of the third comparative example is also able to simplify the configuration of the entire antenna device including the patch antenna 10Z without needing an antenna device of the stacked patch antenna type. The patch antenna 10Z of the third comparative example, however, is different from the patch antenna 10 of an embodiment of the present disclosure described above in that all of the two feeding portions 15 are arranged at the second radiating element 13Z.

The patch antenna 10Z is different from the patch antenna 10 of an embodiment of the present disclosure in that each of the two feeding portions 15 directly feeds the second radiating element 13Z. And, the first radiating element 12Z is electrically coupled to the second radiating element 13Z. Accordingly, with the first radiating element 12Z and the second radiating element 13Z, the patch antenna 10Z is able to operate so as to support radio waves in a plurality of frequency bands.

In the patch antenna 10Y of the second comparative example described above, each of the first radiating element 12Y and the second radiating element 13Y has a shape to support radio waves in a desired frequency band. Thus, as illustrated in FIG. 3B, with the feeding portions 15 being located at the first radiating element 12Y, the shape of the first radiating element 12Y is restricted depending on the positions of the feeding portions 15. For example, when changing the shape of the first radiating element 12Y in order to change the characteristics of the patch antenna 10Y such as changing a frequency band of radio waves to be supported, options of changing the shape of the first radiating element 12Y are limited due to the presence of the feeding portions 15.

Similarly, in the patch antenna 10Z of the third comparative example as well, when the feeding portions 15 are located at the second radiating element 13Z, as illustrated in FIG. 3C, the shape of the second radiating element 13Z is restricted depending on the positions of the feeding portions 15.

Further, as in the patch antenna 10Y of the second comparative example described above, when the feeding portions 15 are located at the first radiating element 12Y, the difference between the distance from the feeding portions 15 to the first radiating element 12Y and the distance from the feeding portions 15 to the second radiating element 13Y may be noticeable. This may cause a noticeable difference in the impedance between the first radiating element 12Y and the second radiating element 13Y. Such a difference in the impedance may result in noticeable difference between the gain in the first radiating element 12Y and the gain in the second radiating element 13Y (specifically, a difference between VSWR values).

Similarly, in the patch antenna 10Z of the third comparative example as well, a noticeable difference between the gain in the first radiating element 12Z and the gain in the second radiating element 13Z (specifically, a difference between VSWR values) may be caused.

Accordingly, in the patch antenna 10Y of the second comparative example illustrated in FIG. 3B and in the patch antenna 10Z of the third comparative example illustrated in FIG. 3C, the shapes of the radiating element 11Y and the radiating element 11Z are restricted depending on the positions of the feeding portions 15, resulting in a low degree of freedom in the design of the patch antennas.

In contrast, in the patch antenna 10 of an embodiment of the present disclosure described above, as illustrated in FIGS. 1 and 2, at least one feeding portion 15 is arranged in a region other than the radiating element 1 (the first radiating element 12 and the second radiating element 13). This can suppress the restriction on the position of the feeding portion 15, even when changing the shape of the first radiating element 12 or the second radiating element 13. Accordingly, with at least one feeding portion 15 being arranged in a region other than the radiating element 11 (the first radiating element 12 and the second radiating element 13), it is possible to enhance the degree of freedom the design of the patch antenna 10.

In the patch antenna 10 of an embodiment of the present disclosure described above, each of the feeding portions 15 is located at the dielectric 14, between the first radiating element 12 and the second radiating element 13 (i.e., in the slot region 30). This can reduce the difference between the distance from the feeding portion 15 to the first radiating element 12 and the distance from the feeding portion 15 to the second radiating element 13. Thus, it is possible to reduce the difference in the impedance between the first radiating element 12 and the second radiating element 13, thereby being able to reduce the difference between the gain in the first radiating element 12 and the gain in the second radiating element 13.

Moreover, in the patch antenna 10 of an embodiment of the present disclosure illustrated in FIGS. 1 and 2, the characteristics of radio waves in the frequency band supported by the first radiating element 12 and the characteristics of radio waves in the frequency band supported by the second radiating element 13 can be adjusted by adjusting at least one of the distance between the feeding portion 15 and the first radiating element 12 and the distance between the feeding portion 15 and the second radiating element 13.

Specifically, in the patch antenna 10 of an embodiment of the present disclosure illustrated in FIGS. 1 and 2, when the characteristics of radio waves in the frequency band supported by the first radiating element 12 are to be enhanced, the distance between the feeding portion 15 and the first radiating element 12 is reduced (i.e., the feeding portion 15 is made closer to the first radiating element 12 side), thereby being able to enhance the characteristics of radio waves in the frequency band supported by the first radiating element 12. In contrast, when the characteristics of radio waves in the frequency band supported by the second radiating element 13 are to be enhanced, the distance between the feeding portion 15 and the second radiating element 13 is reduced (or the feeding portion 15 is made closer to the second radiating element 13 side), thereby being able to enhance the characteristics of radio waves in the frequency band supported by the second radiating element 13.

In other words, in the patch antenna 10 of an embodiment of the present disclosure, it is possible to adjust the characteristics of radio waves in the frequency band supported by the first radiating element 12 and the characteristics of radio waves in the frequency band supported by the second radiating element 13, without changing the shapes of the first radiating element 12 and the second radiating element 13. Thus, with the feeding portion 15 being located at the dielectric 14, between the first radiating element 12 and the second radiating element 13 (i.e., in the slot region 30), it is possible to further enhance the degree of freedom in the design of the patch antenna 10.

### Frequency Characteristics of Patch Antenna 10

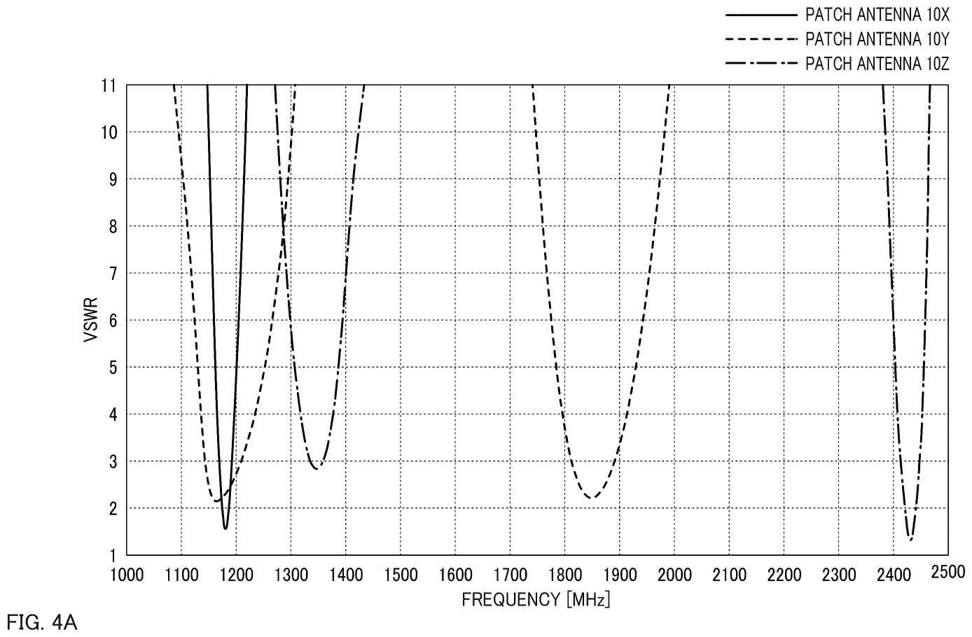

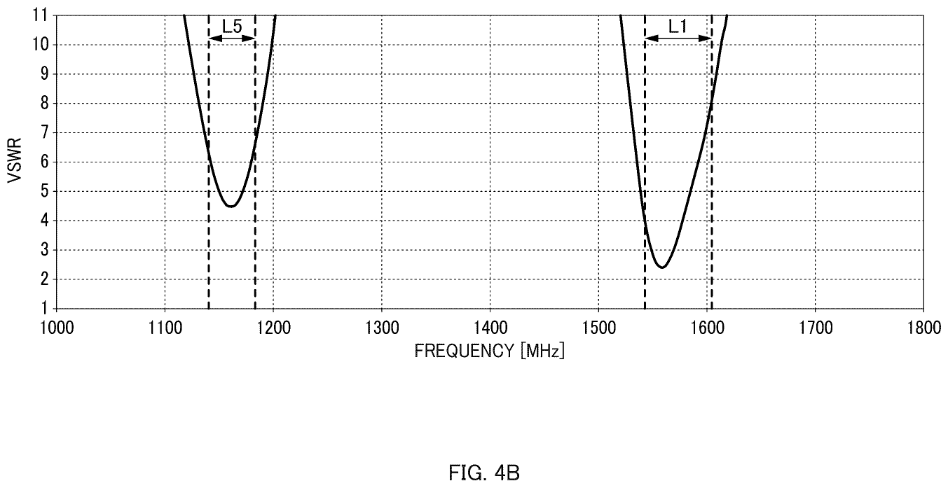

Next, with reference to FIGS. 4A and 4B, the frequency characteristics of the patch antennas 10X to 10Z of the comparative examples and the frequency characteristics of the patch antenna 10 of an embodiment of c the present disclosure will be described.

FIG. 4A is a graph illustrating an example of the frequency characteristics of the patch antenna 10X, the patch antenna 10Y, and the patch antenna 10Z.

In FIG. 4A, the horizontal axis represents the frequency and the vertical axis represents the voltage standing wave ratio (VSWR). As described above, the patch antenna 10X supports radio waves in one frequency band only and the patch antenna 10Y and the patch antenna 10Z each support radio waves in two frequency bands. As illustrated in FIG. 4A, the patch antenna 10X has one point at which the VSWR characteristics are good, in other words, a local minimum value in the graph (solid line). Each of the patch antenna 10Y and the patch antenna 10Z has two points at which the VSWR characteristics are good, in other words, two local minimum values in the graph (dashed lines or dashed-dotted lines). As such, the patch antenna 10X, the patch antenna 10Y, and the patch antenna 10Z each have good characteristics in predetermined frequency bands.

FIG. 4B is a graph illustrating an example of frequency characteristics of the patch antenna 10.

In FIG. 4B as well, the horizontal axis represents the frequency and the vertical axis represents the voltage standing wave ratio (VSWR). As illustrated in FIG. 4B, the patch antenna 10 of an embodiment of the present disclosure has good characteristics in predetermined frequency bands, similarly to the patch antennas 10X to 10Z of the comparative examples. In other words, the patch antenna 10 of an embodiment of the present disclosure has good characteristics in both the L1 band and L5 band that are to be targeted.

### Verification of Width GP of Slot Region 30

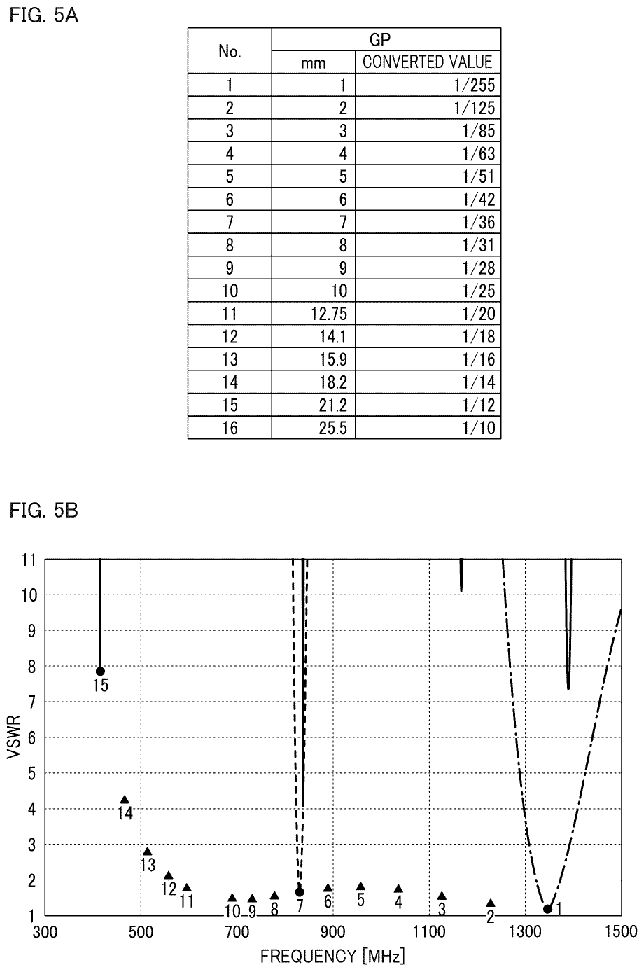

Next, with reference to FIGS. 5A and 5B, verification of the width GP of the slot region 30 in the patch antenna 10 of an embodiment of the present disclosure will be described.

FIG. 5A is a table illustrating widths GP in the patch antenna 10. FIG. 5B is a graph illustrating an example of results when the width GP is changed.

As illustrated in FIG. 5A, the width GP in the patch antenna 10 of an embodiment of the present disclosure was changed in 16 levels (No. 1 to No. 16) from 1 mm to 25.5 mm, and the VSWR was calculated in the patch antenna 10 of each of No. 1 to No. 16. The table illustrated in FIG. 5A indicates, in the patch antenna 10 of each of No. 1 to No. 16, a value of the width GP and a value obtained by converting the value of the width GP with a wavelength in a frequency (here, the center frequency) of the L5 band of the patch antenna 10.

In FIG. 5B, the horizontal axis represents the frequency and the vertical axis represents the voltage standing wave ratio (VSWR). FIG. 5B indicates calculation results (graph) when the width GP of the patch antenna 10 is changed into the values given in the table illustrated in FIG. 5A (the values of the width GP given in No. 1 to No. 16).

In FIG. 5B, the graph indicates only the results of the patch antennas 10 of Nos. 1, 7, and 15. Here, the dotted-dashed line indicates the result of the patch antenna 10 of No. 1, the dashed line indicates the result of the patch antenna 10 of No. 7, and the solid line indicates the result of the patch antenna 10 of No. 15. The local minimum values in the results of Nos. 1, 7, and 15 of the patch antenna 10 are given by black dot signs. In other results of the patch antenna 10 (of No. 2 to No. 6, No. 8 to No. 14), the local minimum values are given by black triangle signs, without the graph thereof being illustrated. In other words, the local minimum values given by the black dot signs and black triangle signs indicate the points at which the VSWR characteristics are good.

As illustrated in FIG. 5B, it can be seen that as an increase in the width GP, the local minimum values of VSWR (black dot signs and black triangle signs) shift to the the low frequency side. Moreover, it can be seen that, as an increase in the width GP, the band gets narrower.

Regarding the patch antenna 10 of No. 16 (width GP=25.5 mm, 1/10 λ), the calculation result (graph) is not seen within the range of VSWR (1 to 11) illustrated in FIG. 5B. Thus, in order to cause the patch antenna 10 to operate in a desired frequency band, it is preferable that the width GP is “larger than 0 and smaller than 1/10 λ”. In other words, it is preferable that the maximum width of the slot region 30 sandwiched by the first radiating element 12 and the second radiating element 13 is smaller than one tenth of the wavelength of radio waves supported by the first radiating element 12 or the second radiating element 13.

### Patch Antennas 10A to 10J of Modification Examples

In the patch antenna 10 of an embodiment of the present disclosure described above, the first radiating element 12 and the second radiating element 13 are arranged at one surface of the top surface of the dielectric 14. The embodiment, however, is not limited to the first radiating element 12 and the second radiating element 13 being arranged at one surface of the top surface of the dielectric 14, but the second radiating element 13 may be arranged at another surface of the top surface of the dielectric 14, as in the patch antenna 10A of the first modification example illustrated in FIG. 6A and the patch antenna 10B of the second modification example illustrated in FIG. 6B. This also makes it possible to enhance the degree of freedom in the design of the patch antenna 10.

FIG. 6A is a perspective view of the patch antenna 10A according to the first modification example. FIG. 6B is a perspective view of the patch antenna 10B according to the second modification example. In FIGS. 6A and 6B, only one feeding portion 15 is illustrated (the same applies to FIGS. 7, 8A, and 8B, which will be described below).

The second radiating element 13 of the patch antenna 10A is, as illustrated in FIG. 6A, arranged at a surface of the dielectric 14, the surface being parallel to a surface of the dielectric 14 at which the first radiating element 12 is arranged and being on the −Z direction side relative to the surface at which the first radiating element 12 is arranged. In other words, the top surface of the dielectric 14 is formed such that a surface of an inner region thereof protrudes to the +Z direction side relative to a surface of an outer region thereof. The first radiating element 12 is arranged at the surface of the inner region of the dielectric 14 and the second radiating element 13 is arranged at the surface of the outer region of the dielectric 14.

The second radiating element 13 of the patch antenna 10B is, as illustrated in FIG. 6B, arranged at a surface of the dielectric 14, the surface being parallel to a surface of the dielectric 14 at which the first radiating element 12 is arranged and being on the +Z direction side relative to the surface at which the first radiating element 12 is arranged. In other words, the top surface of the dielectric 14 is formed such that a surface of an inner region thereof is recessed to the −Z direction side relative to a surface of an outer region thereof. The first radiating element 12 is arranged at the surface of the inner region of the dielectric 14 and the second radiating element 13 is arranged at the surface of the outer region surface of the dielectric 14.

The surface of the dielectric 14 at which the first radiating element 12 is arranged and the surface of the dielectric 14 at which the second radiating element 13 is arranged, illustrated in FIGS. 6A and 6B described above, are parallel to each other. However, one of the surface of the dielectric 14 at which the first radiating element 12 is arranged or the surface of the dielectric 14 at which the second radiating element 13 is arranged may be inclined with respect to the other thereof. Accordingly, one of the first radiating element 12 or the second radiating element 13 may be inclined with respect to the other thereof.

Specifically, for example, when the first radiating element 12 is parallel to the X-Y plane, the second radiating element 13 may be inclined with respect to the X-Y plane, or when the second radiating element 13 is parallel to the X-Y plane, the first radiating element 12 may be inclined with respect to the X-Y plane. Both the first radiating element 12 and the second radiating element 13 may be inclined with respect to the X-Y plane and be parallel to or intersect with each other.

In the patch antenna 10 of an embodiment of the present disclosure described above, the feeding portion 15 is located between the first radiating element 12 and the second radiating element 13 (i.e., in the slot region 30). However, the embodiment is not limited to the feeding portion 15 being located in the slot region 30, but the feeding portion 15 may be located at the dielectric 14 other than the slot region 30, as in the patch antenna 10C of the third modification example illustrated in FIG. 7. This also makes it possible to enhance the degree of freedom in the design of the patch antenna 10.

FIG. 7 is a plan view of the patch antenna 10C according to the third modification example.

The feeding portion 15 of the patch antenna 10C is, as illustrated in FIG. 7, located at the dielectric 14, outside the second radiating element 13. The feeding portion 15 is arranged so as to be electrically coupled only to the second radiating element 13. Here, as in the patch antenna 10 described above, in the patch antenna 10C, the first radiating element 12 and the second radiating element 13 are arranged so as to be electrically coupled to each other. This enables the feeding portion 15 to feed the first radiating element 12 as well through the second radiating element 13.

Further, in the patch antenna 10 of an embodiment of the present disclosure described above, both of the first radiating element 12 and the second radiating element 13 are arranged at the top surface of the dielectric 14. However, the embodiment is not limited to both of the first radiating element 12 and the second radiating element 13 being arranged at the top surface of the dielectric 14, but the second radiating element 13 may be arranged at a position other than the top surface of the dielectric 14, as in the patch antenna 10D of the fourth modification example illustrated in FIG. 8A and the patch antenna 10E of the fifth modification example illustrated in FIG. 8B. This also makes it possible to enhance the degree of freedom in the design of the patch antenna 10.

FIG. 8A is a perspective view of the patch antenna 10D according to the fourth modification example. FIG. 8B is a perspective view of the patch antenna 10E according to the fifth modification example.

In the patch antenna 10D, as illustrated in FIG. 8A, the first radiating element 12 is arranged at the top surface of the dielectric 14 and the second radiating element 13 is arranged at a side surface of the dielectric 14. The second radiating element 13 is located so as to surround the first radiating element 12. The feeding portion 15 of the patch antenna 10D is, as illustrated in FIG. 8A, located at the dielectric 14, between the first radiating element 12 and the second radiating element 13 (i.e., in the slot region 30).

As in the patch antenna 10D, in the patch antenna 10E as well, the first radiating element 12 is arranged at the top surface of the dielectric 14 and the second radiating element 13 is arranged at a side surface of the dielectric 14, as illustrated in FIG. 8B. The second radiating element 13 is located so as to surround the first radiating element 12. The feeding portion 15 of the patch antenna 10E is, as illustrated in FIG. 8B, located at the dielectric 14 (the side surface of the dielectric 14), outside the second radiating element 13.

In the patch antenna 10 of an embodiment of the present disclosure described above, the width GP of the slot region 30 is equal all around the first radiating element 12. However, in at least one of the first radiating element 12 and the second radiating element 13, a cutout part 31 may be be formed, as in the patch antenna 10F of a sixth modification example illustrated in FIG. 9A, a patch antenna 10G of a seventh modification example illustrated in FIG. 9B, and a patch antenna 10H of an eighth modification example illustrated in FIG. 9C. This also makes it possible to enhance the degree of freedom in the design of the patch antenna 10.

FIG. 9A is a plan view of the patch antenna 10F according to the sixth modification example. FIG. 9B is a plan view of the patch antenna 10G according to the seventh modification example. FIG. 9C is a plan view of the patch antenna 10H according to the eighth modification example.

In the patch antenna 10F, as illustrated in FIG. 9A, the second radiating element 13 has a cutout part 31 formed extending in a direction parallel to the width direction of the slot region 30. Here, the cutout part 31 includes a cutout part 32 in which the feeding portion 15 is not arranged and a cutout part 33 in which the feeding portion 15 is arranged. In the patch antenna 10F, all the cutout parts 32 and the cutout parts 33 extend outward.

As in the patch antenna 10F, in the patch antenna 10G, the second radiating element 13 has the cutout part 33 formed therein, the cutout part 33 extending outward and the feeding portion 15 is arranged in the cutout part 33, as illustrated in FIG. 9B. Moreover, in the patch antenna 10G, the first radiating element 12 has other cutout parts 32 and 34 formed therein, the cutout parts 32 and 34 each extending inward. The feeding portion 15 is not arranged in the cutout part 32 and the feeding portion 15 is arranged in the cutout part 34. The cutout part 34 extends from a region in which the feeding portion 15 is located in the slot region 30.

As in the patch antenna 10G, in the patch antenna 10H, the first radiating element 12 has the cutout part 32 formed therein, the cutout part 32 extending inward, as illustrated in FIG. 9C. Moreover, the patch antenna 10H has a cutout part 35 formed therein, the cutout part 35 being obtained by cutting the surrounding of the feeding portion 15.

In the patch antennas 10F to 10H described above, it is possible to form the cutout part 31 in at least one of the first radiating element 12 or the second radiating element 13, without being restricted by the position of the feeding portion 15. In other words, the restriction on the shape of the radiating element 11 depending on the position of the feeding portion 15 is suppressed, thereby being able to enhance the degree of freedom in the design of the patch antenna 10.

As described above, the slot region 30 is formed between the first radiating element 12 and the second radiating element 13. The slot region 30 is defined in various shapes depending on the shape of the outer edge of the first radiating element 12 and the shape of the inner edge of the second radiating element 13. In this event, the shape of the outer edge of the first radiating element 12 and the shape of the inner edge of the second radiating element 13 may be the same shape (for example, the same substantially quadrilateral shape) as or may be different shapes (for example, a substantially quadrilateral shape and a substantially circular shape) from each other.

This makes it possible to form the slot region 30 in various shapes. For example, the slot region 30 may have a shape along the outer shape of a substantially quadrilateral shape, as in the patch antenna 10 or any of the patch antennas 10A to 10G, or may have a shape along the outer shape of a substantial circular shape, as in the patch antenna 10H. The slot region 30 may have a shape along the outer shape of a circular shape, an elliptical shape, a polygonal shape, or the like, or may have a shape of combination of these.

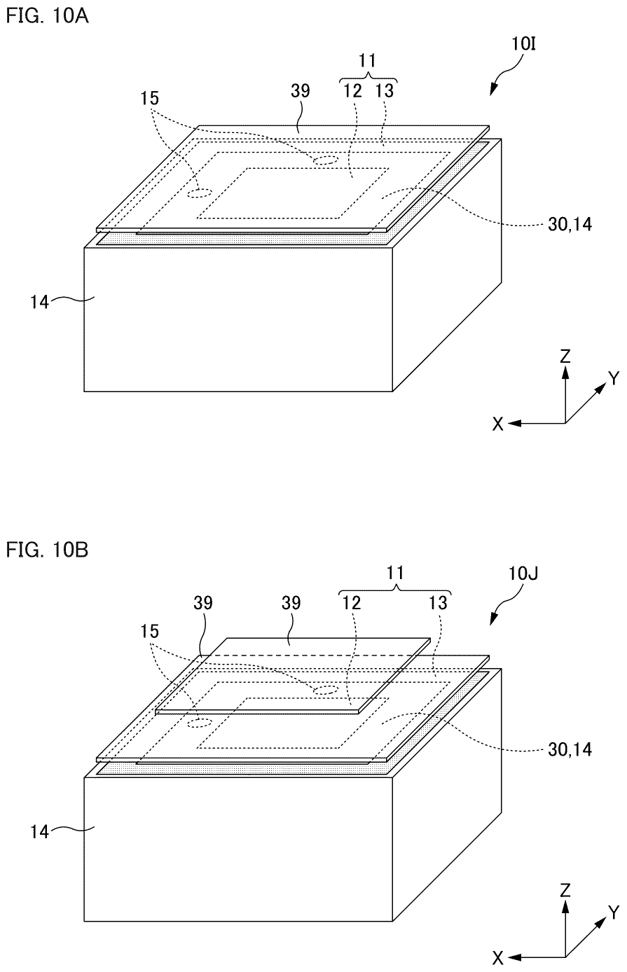

FIG. 10A is a perspective view of a patch antenna 10I according to a ninth modification example. FIG. 10B is a perspective view of a patch antenna 10J according to a tenth modification example.

The patch antenna 10I includes a parasitic element 39 as illustrated in FIG. 10A. The parasitic element 39 is a conductive member arranged on the upper side relative to the radiating element 11 and is a metal plate formed of sheet metal. In the patch antenna 10I, as illustrated in FIG. 10A, one single parasitic element 39 is arranged on the upper side relative to the radiating element 11 of the patch antenna 10I. The parasitic element 39 may be held by a holding member (not illustrated) surrounding the radiating element 11. The patch antenna 10I includes the parasitic element 39, thereby being able to improve an axial ratio of a low elevation angle (for example, a range of from 0 to 30 degrees), in particular.

The patch antenna 10J includes a parasitic element 39, similarly to the patch antenna 10I of the ninth modification example described above. In the patch antenna 10J, as illustrated in FIG. 10B, two parasitic elements 39 are arranged on the upper side relative to the radiating element 11 of the patch antenna 10J. The two parasitic elements 39 may be held by a holding member (not illustrated) surrounding the radiating element 11. The patch antenna 10J includes the two parasitic elements 39, thereby being able to further improve an axial ratio of a low elevation angle, in particular.

### Procedure of Assembling Patch Antenna 10

### Overview

Next, a procedure of assembling the patch antenna 10 of an embodiment of the present disclosure will be described. In the patch antennas 10X to 10Z of the comparative examples described above, the feeding portion 15 is arranged at the radiating element (11X, 11Y, 11Z). Thus, in the patch antennas 10X to 10Z of the comparative examples, the feeding portion 15 and the radiating element (11X, 11Y, 11Z) are soldered to be electrically connected to each other, resulting in the feeding portion 15 being fixed to the radiating element (11X, 11Y, 11Z).

In contrast, in the patch antenna 10 of an embodiment of the present disclosure, the feeding portion 15 is arranged in a region other than the radiating element 11 (the first radiating element 12 and the second radiating element 13). Specifically, the feeding portion 15 is located at the dielectric 14, between the first radiating element 12 and the second radiating element 13 (i.e., in the slot region 30), and thus the feeding portion 15 and the dielectric 14 need to be fixed to each other in the patch antenna 10 of an embodiment of the present disclosure. The following describes, in particular, a procedure of fixing the feeding portion 15 and the dielectric 14 to each other, in a procedure of assembling the patch antenna 10 of an embodiment of the present disclosure.

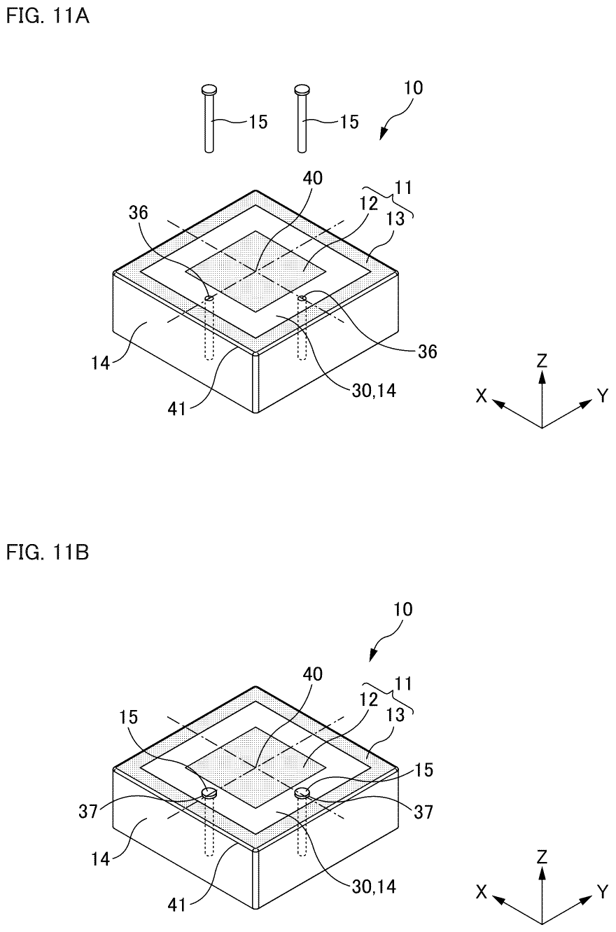

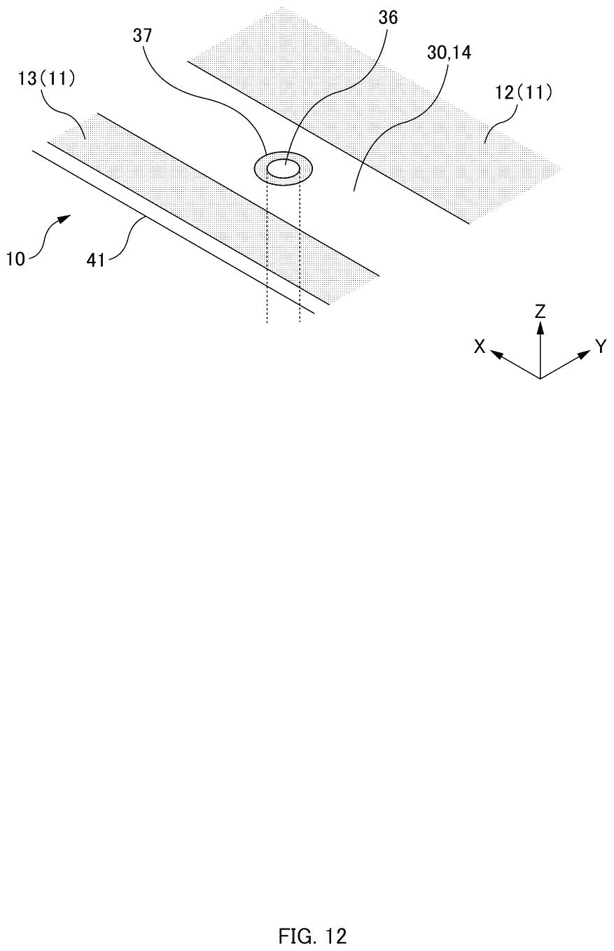

FIG. 11A is a perspective view illustrating a state before fitting each feeding portion 15 into the dielectric 14, with respect to a first example of the procedure of assembling the patch antenna 10. FIG. 11B is a perspective view illustrating a state after fitting the feeding portion 15 into the dielectric 14, with respect to the first example of the procedure of assembling the patch antenna 10. FIG. 12 is an enlarged perspective view of a pinhole 36 in the dielectric 14 and the vicinity thereof.

As illustrated in FIG. 11A, in the dielectric 14, the pinhole 36 for the feeding portion 15 to be inserted thereinto is formed in advance. Then, the feeding portion 15 is inserted into the pinhole 36 and the feeding portion 15 is fixed to the dielectric 14 with fixing part 37, as illustrated in FIG. 11B. Here, the fixing part 37 is adhesive or the like.

However, the method of fixing the feeding portion 15 and the dielectric 14 to each other is not limited to the case of fixing them with adhesive or the like. In other words, the fixing part 37 is not limited to an insulating member such as adhesive, but may be a conductive member including solder. As illustrated in FIG. 12, a conductive member as a part of the fixing part 37 may be arranged in advance around the pinhole 36 in the dielectric 14, and the feeding portion 15 and the conductive member may be fixed to each other, further by solder as a part of the fixing part 37. However, the conductive member illustrated in FIG. 12 may be omitted.

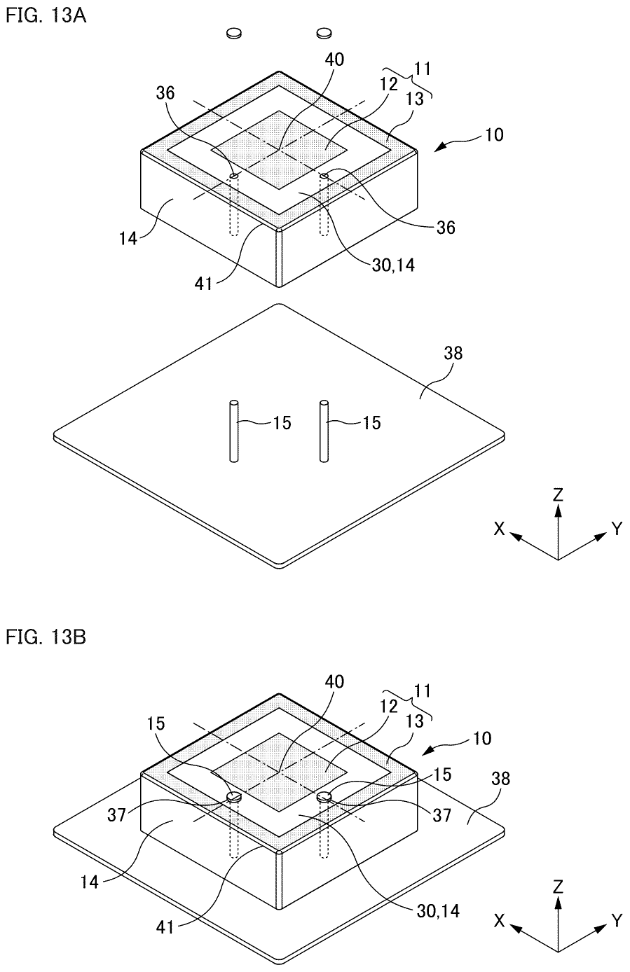

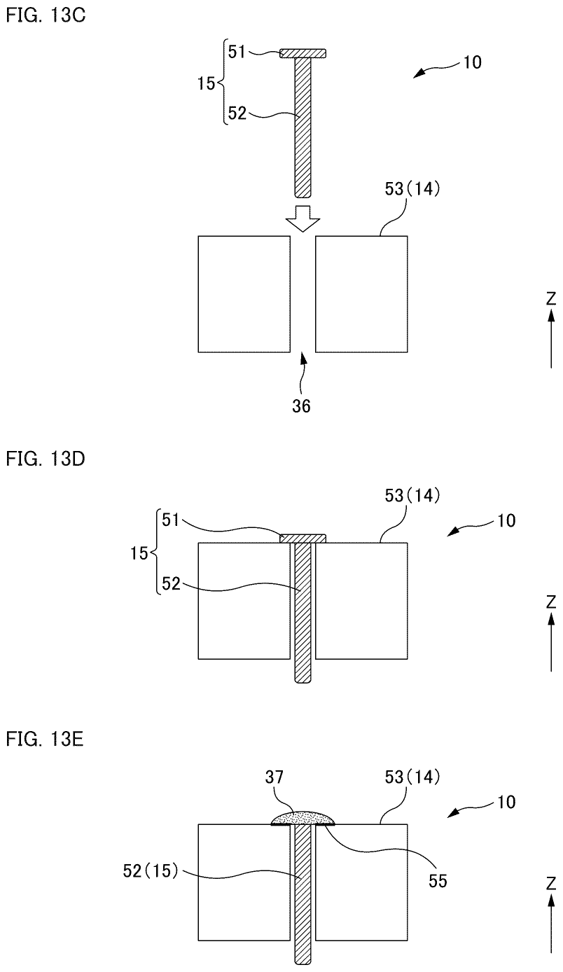

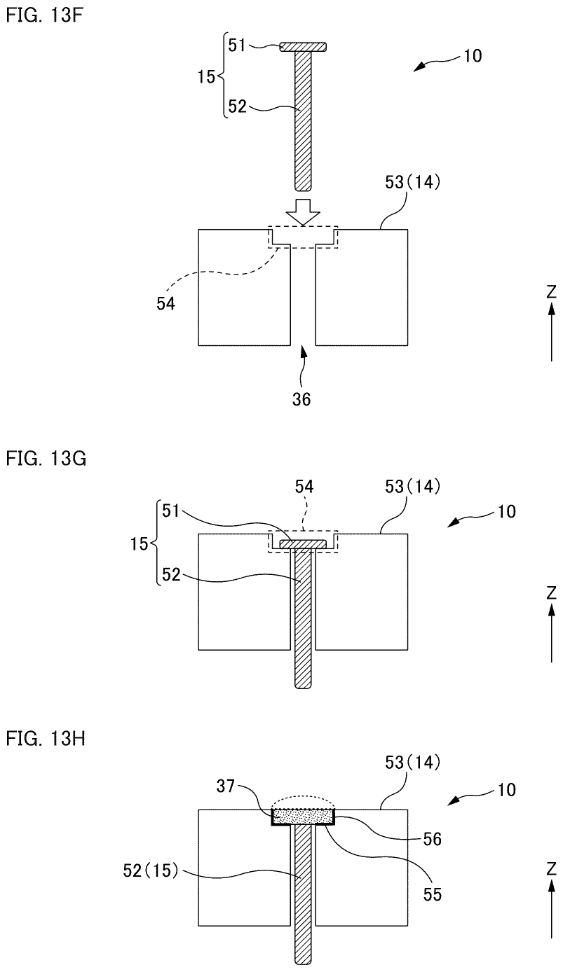

FIG. 13A is a perspective view illustrating a state before fitting each feeding portion 15 into the dielectric 14, with respect to a second example of the procedure of assembling the patch antenna 10. FIG. 13B is a perspective view illustrating a state after fitting the feeding portion 15 into the dielectric 14 with respect to the second example of the procedure of assembling the patch antenna 10.

As illustrated in FIG. 13A, as another example of the procedure of assembling the patch antenna 10, the feeding portion 15 may be fixed in advance to a substrate 38 for the patch antenna 10 to be mounted thereto. Then, as illustrated in FIG. 13B, the feeding portion 15 may be inserted into the pinhole 36 such that the patch antenna 10 is put onto the substrate 38 side. In the second example of the procedure of assembling the patch antenna 10 illustrated in FIGS. 13A and 13B, the feeding portion 15 being fixed in advance makes it possible to enhance workability in assembling the patch antenna 10. The feeding portion 15 being fixed in advance to the substrate 38 facilitates positioning in mounting the patch antenna 10 to the substrate 38.

### Fixing Method

As described above, the feeding portion 15 and the dielectric 14 are fixed to each other by adhesive or the like or by the fixing part 37 formed of a conductive member. The following describes a fixing method with the fixing part 37 in detail. The fixing method, which will be described below, is described as a fixing method in the first example of the procedure of assembling the patch antenna 10 illustrated in FIGS. 11A, 11B, and 12 described above. However, this may be also applied to a fixing method in the second example of the procedure of assembling the patch antenna 10 illustrated in FIGS. 13A and 13B.

FIG. 13C is an explanatory diagram illustrating a state before inserting the feeding portion 15 into the pinhole 36, in a first example of a method of fixing the dielectric 14 and the feeding portion 15 to each other. FIG. 13D is an explanatory diagram illustrating a state after inserting the feeding portion 15 into the pinhole 36, in the first example of the method of fixing the dielectric 14 and the feeding portion 15 to each other. FIG. 13E is an explanatory diagram illustrating a state of fixing the feeding portion 15 and the dielectric 14 to each other, in the first example of the method of fixing the dielectric 14 and the feeding portion 15 to each other.

As illustrated in FIG. 13C, the feeding portion 15 to be inserted into the pinhole 36 in the dielectric 14 includes a head part 51 and a trunk part 52. The head part 51 is a part located on the +Z direction side of the feeding portion 15. In a state in which the feeding portion 15 has been inserted in the pinhole 36 in the dielectric 14 (the state of FIG. 13D which will be described below), the head part 51 is exposed on the +Z direction side of the dielectric 14. The trunk part 52 is a part located on the −Z direction side of the feeding portion 15 and is to be inserted into the pinhole 36 in the dielectric 14.

The dielectric 14 has the pinhole 36 formed extending in the Z direction. In the first example of the method of fixing the dielectric 14 and the feeding portion 15 to each other, the inner diameter of the pinhole 36 is a fixed inner diameter over the Z direction, is larger than the outer diameter of the trunk part 52 of the feeding portion 15, and is smaller than the outer diameter of the head part 51 of the feeding portion 15. This makes it possible to, as illustrated in FIG. 13D, insert the trunk part 52 into the pinhole 36, resulting in the end of the head part 51 on the +Z direction side being located on the upper side (+Z direction side) relative to the surface of the dielectric 14 on the +Z direction side, in a state in which the trunk part 52 has been inserted in the pinhole 36.

The fixing part 37 is arranged so as to cover the head part 51, as illustrated in FIG. 13E. In the state in which the trunk part 52 has been inserted in the pinhole 36 (the state illustrated in FIG. 13D), the end of the head part 51 on the +Z direction side is located on the upper side (+Z direction side) relative to a top surface 53 (the surface on the +Z direction side) of the dielectric 14, and thus the fixing part 37 covering the head part 51 resulting in being located further on the upper side (+Z direction side) relative to the position of the head part 51.

The fixing part 37 is arranged also between the bottom surface (the surface on the −Z direction side) of the head part 51 and the top surface 53 (the surface on the +Z direction side) of the dielectric 14 facing the head part 51, to thereby

form an adhesive face 55 between the feeding portion 15 and the dielectric 14. In the state in which the trunk part 52 has been inserted in the pinhole 36 (the state illustrated in FIG. 13D), the head part 51 is located on the upper side (+Z direction side) relative to the surface on the +Z direction side of the dielectric 14 (the top surface 53 of the dielectric 14), and thus the adhesive face 55 is not formed on a side surface of the head part 51.

FIG. 13F is an explanatory diagram illustrating a state before inserting the feeding portion 15 into the pinhole 36, in a second example of the method of fixing the dielectric 14 and the feeding portion 15 to each other. FIG. 13G is an explanatory diagram illustrating a state after inserting the feeding portion 15 into the pinhole 36, in the second example of the method of fixing the dielectric 14 and the feeding portion 15 to each other. FIG. 13H is an explanatory diagram illustrating a state of fixing the feeding portion 15 and the dielectric 14 to each other, in the second example of the method of fixing the dielectric 14 and the feeding portion 15 to each other.

As illustrated in FIG. 13F, in the second example of the method of fixing the dielectric 14 and the feeding portion 15 to each other described above, a head part accommodating portion 54 may be formed in a portion on the +Z direction side of the pinhole 36. The head part accommodating portion 54 is a portion obtained by increasing the inner diameter of the pinhole 36. The head part accommodating portion 54 has an inner diameter larger than the outer diameter of the head part 51 of the feeding portion 15. This makes it possible to, as illustrated in FIG. 13G, insert the trunk part 52 into the pinhole 36, as well as insert the feeding portion 15 into the pinhole 36 with the head part 51 being positioned on the lower side relative to the surface on the +Z direction side of the dielectric 14 (the top surface 53 of the dielectric 14). In FIG. 13G, the entire head part 51 is positioned on the lower side relative to the surface on the +Z direction side of the dielectric 14 (the top surface 53 of the dielectric 14), however, a part of the head part 51 may be positioned on the lower side relative to the surface on the +Z direction side of the dielectric 14 (the top surface 53 of the dielectric 14).

The fixing part 37 is arranged so as to cover the head part 51 as illustrated in FIG. 13H. In the state in which the trunk part 52 has been inserted in the pinhole 36 (the state illustrated in FIG. 13G), the head part 51 is located on the lower side (−Z direction side) as compared with the case of the first example described above (the case illustrated in FIG. 13D), and thus the fixing part 37 covering the head part 51 can be arranged so as to be positioned on the lower side (−Z direction side) as compared with the case of the first example. For comparison, in FIG. 13H, the outer shape of the fixing part 37 in the first example is given by a dashed line. This makes it possible to, in the second example, achieve the height of the patch antenna 10 lower than that in the first example. In the second example, the fixing part 37 covering the head part 51 is located at the same position as or lower than the top surface 53 of the dielectric 14. In other words, the entirety of the fixing part 37 is accommodated in the head part accommodating portion 54. However, only a part of the fixing part 37 may be accommodated in the head part accommodating portion 54.

The fixing part 37 is, as in the case of the first example, arranged also between the bottom surface (the surface on the −Z direction side) of the head part 51 and the bottom surface of the head part accommodating portion 54 facing the bottom surface of the head part 51, to thereby form the adhesive face 55 between the feeding portion 15 and the dielectric 14. Moreover, the case of the second example is different from the case of the first example in that the fixing part 37 is arranged also between a side surface of the head part 51 and the inner side surface of the head part accommodating portion 54 facing the side surface of the head part 51, to thereby form an adhesive face 56 on the side surface side of the head part 51. This makes it possible to, in the second example, increase the adhesion area between the feeding portion 15 and the dielectric 14 to be larger than in the case of the first example, thereby being able to enhance the adhesive strength between the feeding portion 15 and the dielectric 14.

### Others

### Electrical Action of Feeding Portion 15:

In the patch antenna 10 of an embodiment of the present disclosure and the patch antennas 10A to 10J of the modification examples, the feeding portion 15 is arranged so as to be electrically coupled to at least one of the first radiating element 12 or the second radiating element 13. In the following, the electrical action of the feeding portion 15 onto the first radiating element 12 and the second radiating element 13 will be described, using the patch antenna 10H of the eighth modification example as an example.

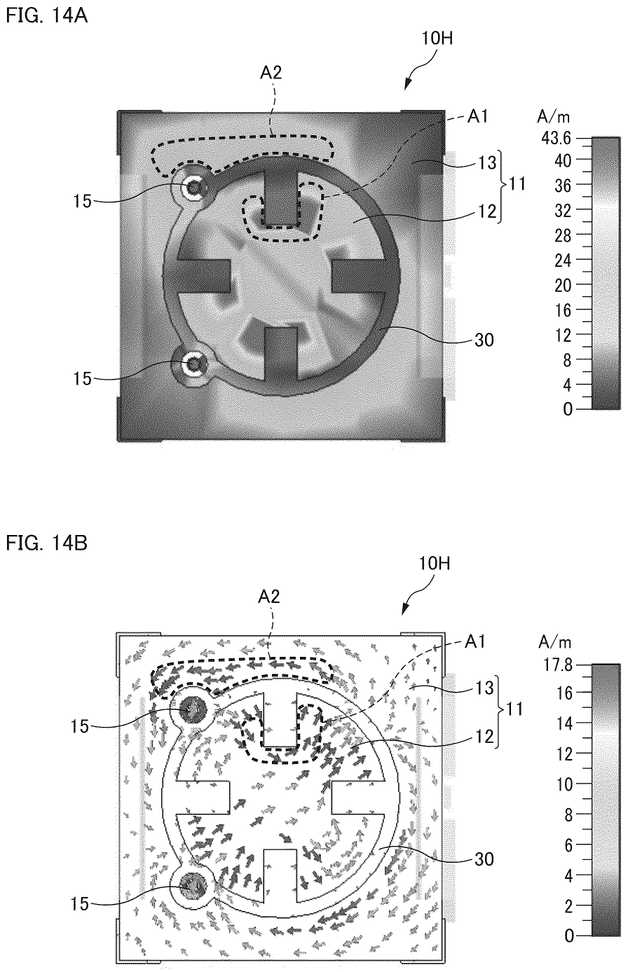

FIG. 14A is an example of a current distribution diagram in the patch antenna 10H. FIG. 14B is another example of the current distribution diagram in the patch antenna 10H.

FIG. 14A visually illustrates a current is distributed in the top surface of the patch antenna 10H. FIG. 14B visually illustrates, in particular, the direction of the current with respect to the current distribution in the top surface of the patch antenna 10H. In each of FIGS. 14A and 14B, examples of regions in which the current is strong are surrounded with dashed lines. Out of the regions in which the current is strong, an example of the region in which the current is strong in the first radiating element 12 is referred to as A1 region, and an example of the region in which the current is strong in the second radiating element 13 is referred to as A2 region. The A1 region and the A2 region are each a region in which the degree of electrical coupling is large.

As illustrated in FIGS. 14A and 14B, the current is strong, for example, in the A1 region and the A2 region located on both sides of the slot region 30. In other words, the feeding portion 15 feeds both of the first radiating element 12 and the second radiating element 13 through the slot region 30. Therefore, the feeding portion 15 is electrically to coupled to the first radiating element 12 and the second radiating element 13, and arranged so as to simultaneously act on both the radiating elements (first radiating element 12 and the second radiating element 13).

The description above uses the case of the patch antenna 10H as an example of electrical action of the feeding portion 15 onto the first radiating element 12 and the second radiating element 13. Similarly, in the patch antenna 10 of an embodiment of the present disclosure and in the patch antennas of the modification examples, other than the patch antenna 10H, as well, the feeding portion 15 is electrically coupled to the first radiating element 12 and the second radiating element 13, and arranged so as to simultaneously act on both the radiating elements (first radiating element 12 and the second radiating element 13).

### Feed Circuit of Patch Antenna 10:

As described above, the patch antenna 10 of an embodiment of the present disclosure employs a double-feed system. The following describes an example of a feed circuit of the patch antenna 10 that employs a double-feed system.

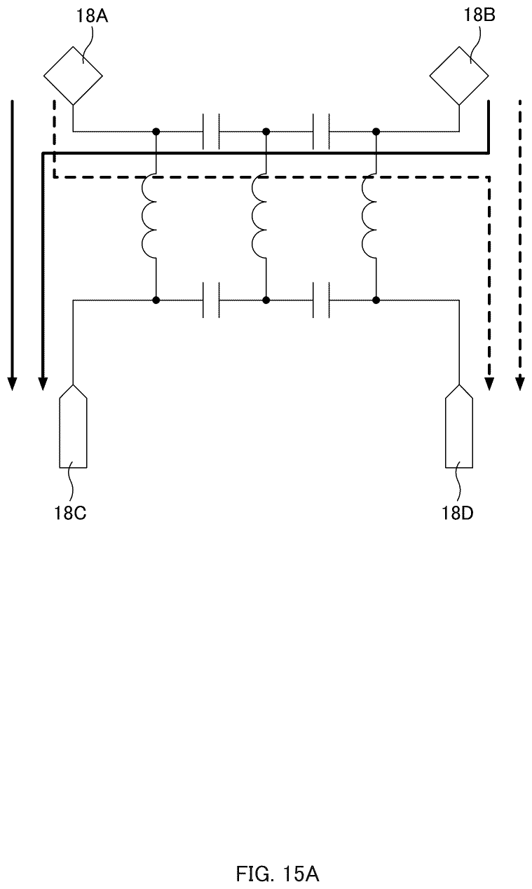

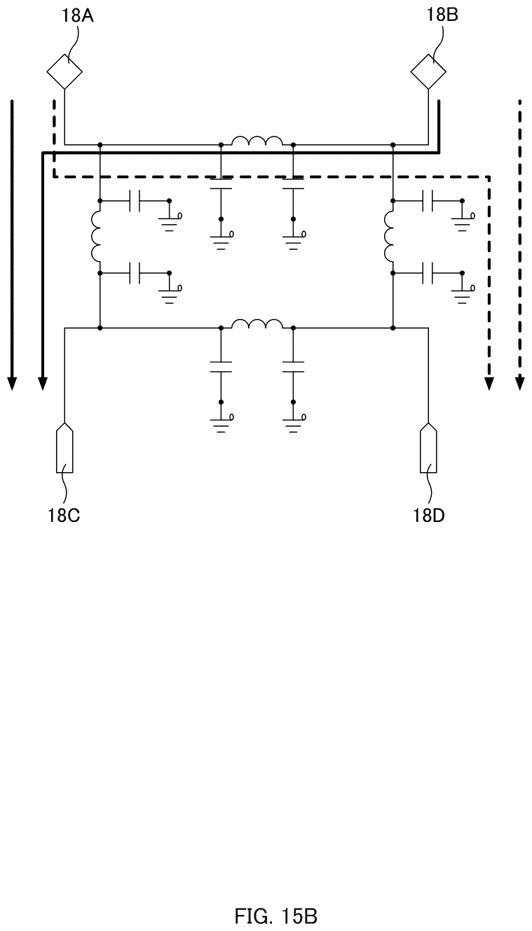

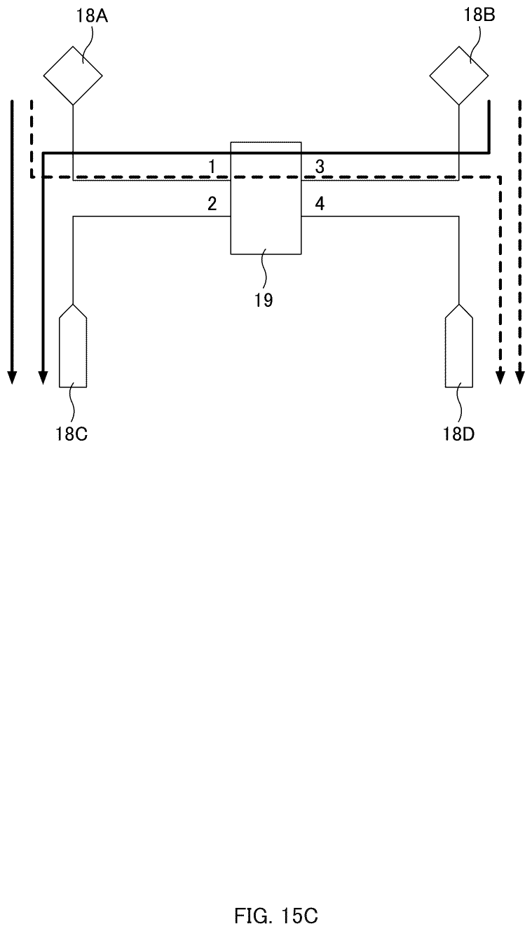

FIG. 15A is a first example of a circuit diagram of the patch antenna 10. FIG. 15B is a second example of the circuit diagram of the patch antenna 10. FIG. 15C is a third example of the circuit diagram of the patch antenna 10.

In FIGS. 15A to 15C, a path of a signal transmitted from an antenna input part 18A or an antenna input part 18B to an antenna output part 18C is given by an arrowed solid line. A path of a signal transmitted from the antenna input part 18A or the antenna input part 18B to an antenna output part 18D is given by an arrowed dashed line.

The first example of the circuit diagram illustrated in FIG. 15A and the second example of the circuit diagram illustrated in FIG. 15B illustrate an example in which the feed circuit includes a combination of two types of circuit elements that are an inductor L and a capacitor C. FIG. 15C illustrates an example in which a hybrid coupler 19 is used. As illustrated in FIGS. 15A to 15C, signals that are inputted from the antenna input part 18A or the antenna input part 18B and that have phases different from each other by 90 degrees, are transmitted to the antenna output part 18C or the antenna output part 18D. Accordingly, the patch antenna 10 supports desired circularly polarized waves corresponding to a frequency band for GNSS, for example.

The patch antenna 10 in an embodiment of the present disclosure described above supports, for example, radio waves in a frequency band for GNSS. However, the patch antenna 10 may support, for example, radio waves in a frequency band for SDARS. The radio waves in the frequency band for GNSS are right-hand circularly polarized waves and the radio waves in the frequency band for SDARS are left-hand circularly polarized waves.

Here, in the patch antenna 10, the first radiating element 12 may support the right-hand circularly polarized waves and the second radiating element 13 may support the left-hand circularly polarized waves. In the patch antenna 10, alternatively, the first radiating element 12 may support the left-hand circularly polarized waves and the second radiating element 13 may support the right-hand circularly polarized waves. Accordingly, in the patch antenna 10, the entire antenna device including the patch antenna 10 is able to have a simple configuration, while the patch antenna 10 supports radio waves in a given plurality of frequency bands.

### Overview of Antenna Device 100

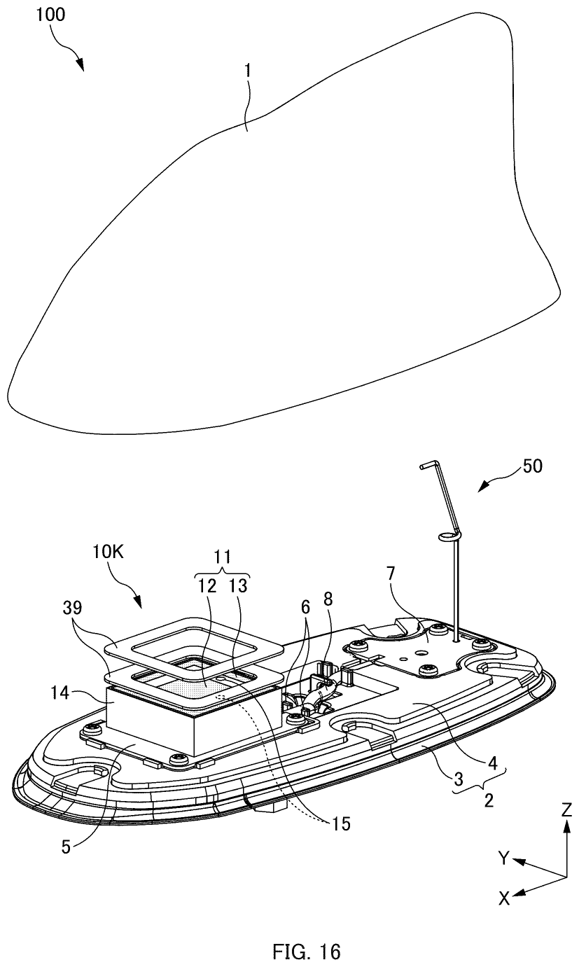

FIG. 16 is an exploded perspective view of an antenna device 100 according to the first embodiment. FIG. 16 is a diagram illustrating the antenna device 100 with a case 1, which will be described below, removed and moved to the +Z direction side. In FIG. 16, illustration of a holding member holding the parasitic element 39 in a patch antenna 10K, which will be described below, and a holding member holding an antenna 50, which will be described below, is omitted.

The antenna device 100 of an embodiment of the present disclosure is a so-called vehicular antenna device, and is to be arranged at a roof of a vehicle, for example. A part of the vehicle at which the antenna device 100 is to be arranged may be changed as appropriate depending on an environment condition such as an assumed communication target. The antenna device 100 may be arranged, for example, at various positions of the vehicle, such as an upper part of a dashboard, a bumper, a mounting part of a license plate, a pillar part, a spoiler part, and the like.

Here, the term “vehicular” refers to being mountable to a vehicle, and thus it is not limited to one mounted to the vehicle, but also includes one to be brought into the vehicle to be used in the vehicle. Further, it is assumed that the antenna device 100 of an embodiment of the present disclosure is used for a “vehicle” that is a wheeled vehicle, however, it is not limited thereto, and the antenna device 100 may be used for, for example, a movable object such as a fight vehicle such as a drone, a probe vehicle, construction machinery, agricultural machinery, or a vessel, and the like without a wheel.

In FIG. 16, the +X direction is a forward direction when seen from a driver's seat in the vehicle at which the antenna device 100 is arranged, the +Y direction is a right direction when seen from the driver's seat in the vehicle at which the antenna device 100 is arranged, and the +Z direction is an up direction (zenith direction) when seen from the driver's seat in the vehicle the antenna device 100 is arranged.

The outer shape of the antenna device 100 of an embodiment of the present disclosure (i.e., the outer shape of the case 1, which will be described later) is in a fin shape (i.e., shark-fin shape) for regulating flow of traveling wind when driving the vehicle, to reduce the fluid resistance. Specifically, in a top view, the outer shape of the antenna device 100 of an embodiment of the present disclosure is such that the front thereof is tapered and the width thereof in the left-right direction increases toward the rear thereof. In a back view, the outer shape of the antenna device 100 of an embodiment of the present disclosure is such that the width thereof in the left-right direction gradually decreases upward from the mounting surface thereof to be mounted to the vehicle toward the top thereof.

In other words, the antenna device 100 of an embodiment of the present disclosure has a streamlined outer shape in which the width and height thereof relatively decrease and the side-faces thereof are inwardly curved toward the front end. However, the outer shape of the antenna device 100 is not limited thereto, and may be, for example, any one of various shapes such as a cube, a rectangular parallelepiped, a cone, a pyramid, and a sphere or a combination thereof.

Although not illustrated in FIG. 16, the antenna device 100 may be accommodated in a cavity between a roof panel of the vehicle and a roof lining on a ceiling of the vehicle, for example. In this case, the roof panel of the vehicle is, for example, formed of an insulating resin such that the antenna device 100 can support radio waves. The antenna device 100 accommodated in the cavity between the roof panel of the vehicle and the roof lining on the ceiling of the vehicle is to be fixed to the roof lining formed of an insulating resin using, for example, a vis and/or the like. The antenna device 100 accommodated in the cavity may be fixed to a frame, the roof panel, or the like. The roof panel of the vehicle may be formed of metal or carbon fiber reinforced plastics, in stead of resin. When the roof panel of the vehicle is formed of, for example, metal, means of ensuring the directivity of an antenna included in the antenna device 100 may be provided.

The antenna device 100 includes the case 1, a base 2, the patch antenna 10K, and the antenna 50.

The case 1 is a member to form, with the base 2, a space for accommodating the patch antenna 10K and the antenna 50. In an embodiment of the present disclosure, the case 1 constitutes an upper side of the antenna device 100. Further, in an embodiment of the present disclosure, the case 1 is formed of an insulating resin material. However, the case 1 may be formed of a material that is other than an insulating resin material and that allows radio waves to pass therethrough. The case 1 may include a part formed of an insulating resin material and a part formed of another material allowing radio waves to pass therethrough, and these materials may be freely combined. The case 1 is fixed to the base 2 with screw (not illustrated). The case 1 is not limited to the case of being fixed with a screw, but may be fixed to the base 2 by snap-fit, welding, bonding, or the like.

The base 2 is a member to form, with the case 1, a space for accommodating the patch antenna 10K and the antenna 50. In an embodiment of the present disclosure, the base 2 constitutes a bottom surface of the antenna device 100. The base 2 includes an insulating base 3 and a metal base 4 as illustrated in FIG. 16.

The insulating base 3 is a plate-shaped member formed of an insulating resin material. However, the insulating base 3 may be formed of a material other than a resin material, as long as having insulation properties, and may have a shape other than a plate shape. The metal base 4 is fixed to the insulating base 3 with a screw (not illustrated).

The metal base 4 is a member configured to function as a ground of the antenna device 100. The metal base 4 is, for example, a plate-shaped member made of metal and is a die-cast product of aluminum alloy or the like. However, the metal base 4 may have a shape other than a plate shape, as long as it is a member made of metal to function as a ground, and may be formed of sheet metal. At the metal base 4, a substrate 5 to which the patch antenna 10K is connected and a substrate 7 to which the antenna 50 is connected are arranged, as illustrated in FIG. 16. In other words, at the metal base 4, the patch antenna 10K is arranged through the substrate 5 and the antenna 50 is arranged through the substrate 7.

When the antenna device 100 is arranged at the roof of the vehicle, the metal base 4 is electrically connected to the roof. This causes the metal base 4 to function as a ground of the patch antenna 10K and the antenna 50 included in the antenna device 100. The metal base 4 is an integral metal base at which the substrate 5 and the substrate 7 are arranged, however, the metal base 4 may be configured as separated metal bases, which are a metal base at which the substrate 5 is arranged and a metal base at which the substrate 7 is arranged. Even when the metal base 4 is configured as such separated metal bases, the metal base 4 appropriately functions as grounds of the patch antenna 10K and the antenna 50.

The above describes that the antenna device 100 includes the base 2 as a member constituting the bottom surface of the antenna device 100. In addition, it also describes that the base 2 includes the insulating base 3 and the metal base 4 that functions as the ground(s). However, the configuration of the base 2 is not limited to the above.

For example, the base 2 may include the metal base 4 only, may include the insulating base 3, metal base 4, and another metal base, or may include a metal plate instead of the metal base. The base 2 may include the insulating base 3 and the metal plate that serves as a substitute for the metal base.

In the antenna device 100 of an embodiment of the present disclosure, the above-described members may be freely combined, as a member constituting the bottom surface of the antenna device 100 and a member configured to function as the ground.

In an embodiment of the present disclosure, the case 1 and the base 2 accommodate the patch antenna 10K and an antenna 50. In other words, the case 1 and the base 2 forms a space for accommodating at least the patch antenna 10K and the antenna 50. However, the case 1 and the base 2 may accommodate a member other than the patch antenna 10K and the antenna 50. In an embodiment of the present disclosure, the case 1 and the base 2 form a casing of a shark-fin antenna.

For the patch antenna 10K, similarly to the patch antenna 10I illustrated in FIG. 10B, two parasitic elements 39 are arranged on the upper side relative to the radiating element 11 of the patch antenna 10K. Each of the parasitic elements 39 is formed in a shape obtained by hollowing out an inner region, as illustrated in FIG. 16. In the patch antenna 10K in the antenna device 100 of an embodiment of the present disclosure as well, the feeding portion 15 located in a region (here, in the slot region 30) other than the radiating element 11, thereby being able to enhance the degree of freedom in the design of the patch antenna 10K.

The patch antenna 10K is arranged at the substrate 5 attached to the top surface of the metal base 4, as illustrated in FIG. 16. Here, the patch antenna 10K is electrically connected to the substrate 5 with the feeding portion 15. The patch antenna 10K is connected to coaxial cables 6 illustrated in FIG. 16 through a matching circuit (not illustrated) mounted to the substrate 5.

The antenna 50 is an antenna for mobile communication, and is used for Vehicle to Everything (V2X) (vehicle-to-vehicle communication, road-to-vehicle communication), for example. The antenna 50 is an antenna that supports radio waves of linearly polarized waves. The linearly polarized waves may be, for example, referred to as vertical polarized waves when the polarization plane is vertical to the earth and may be referred to as horizontal polarized waves when the polarization plane is horizontal to the earth. The antenna 50 is a collinear antenna array. However, examples of the antenna 50 may include a monopole antenna, a sleeve antenna, a dipole array antenna, a slot array antenna, a Yagi antenna, a patch antenna, and the like.

The antenna 50 is arranged at the substrate 7 attached to the top surface of the metal base 4, as illustrated in FIG. 16. Here, the antenna 50 is electrically connected to the substrate 7 at a feeding portion (not illustrated). The antenna 50 is connected to a coaxial cable 8 illustrated in FIG. 16 through a matching circuit (not illustrated) mounted to the substrate 7. A circuit element and/or an electronic component other than the matching circuit may be mounted at the substrate 7.

Here, the outer circumference of the substrate 7 on the matching-circuit side (lower side) is electrically connected to the ground on the antenna 50 side, with a through-hole, via hole, and/or the like. The outer circumference of the substrate 7 on the matching-circuit side is subjected to conductive surface treatment such as solder leveling or gold plating.

As described above, the antenna device 100 includes the antenna 50 in addition to the patch antenna 10K, but the antenna device 100 may include an antenna other than the antenna 50 or may include the patch antenna 10K only.

### Second Embodiment

### Overview of Patch Antenna 20

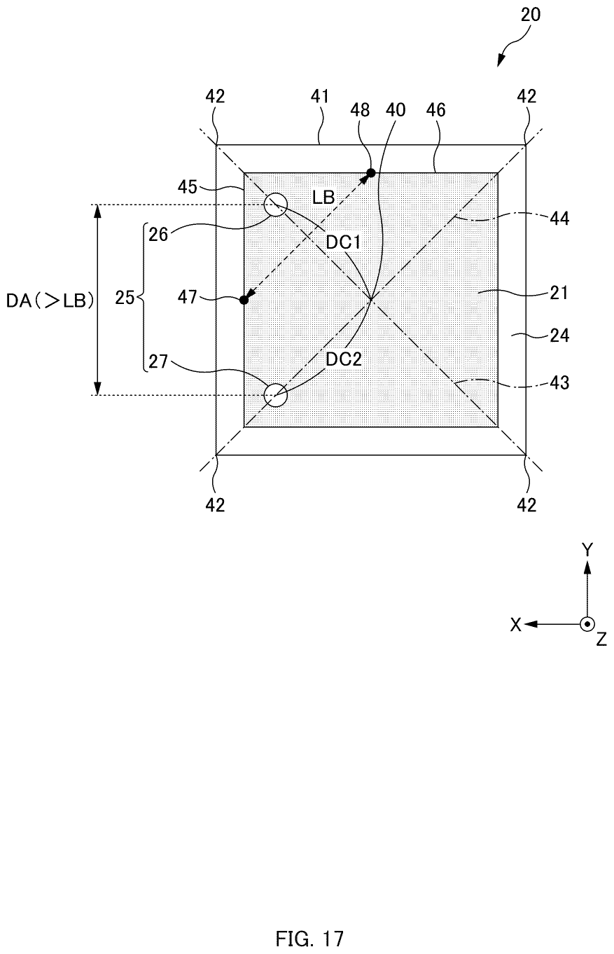

FIG. 17 is a plan view of a patch antenna 20 according to a second embodiment.

The patch antenna 20 includes a radiating element 21, a dielectric 24, a first feeding portion 26, and a second feeding portion 27, similarly to the patch antenna 10 of the first embodiment. In the following description, the first feeding portion 26 and the second feeding portion 27 may be collectively referred to as “feeding portion 25”.

The radiating element 21 is a conductive member arranged at the dielectric 24. The patch antenna 20 of an embodiment of the present disclosure is different from the patch antenna 10 of the first embodiment described above in that the radiating element 21 supports radio waves in one frequency band only. The radiating element 21 includes only one radiating element, without including two radiating elements as of the first radiating element 12 and the second radiating element 13 of the patch antenna 10 of the first embodiment described above. However, the radiating element 21 may include a first radiating element and a second radiating element, as in the patch antenna 10 of the first embodiment described above, and may support radio waves in a plurality of frequency bands.

The dielectric 24 is a member formed of a dielectric material such as ceramics, as in the patch antenna 10 of the first embodiment described above. The dielectric 24 has a substantially quadrilateral shape in plan view. However, the shape of the dielectric 24 is not limited to the substantially quadrilateral shape, but may be, for example, a shape such as a circular shape, an elliptical shape, a polygonal shape, or the like. Details of the dielectric 24 other than the above are similar to those of the dielectric 14 in the patch antenna 10 of the first embodiment described above, and thus the description thereof is omitted.

Each of the first feeding portion 26 and the second feeding portion 27 is a conductive member including a feeding point. The patch antenna 20 of an embodiment of the present disclosure is different from the patch antenna 10 of the first embodiment described above in that the first feeding portion 26 and the second feeding portion 27 are each arranged at the radiating element 21. However, as in the patch antenna 10 of the first embodiment described above, at least one of the first feeding portion 26 and the second feeding portion 27 may be arranged in a region other than the radiating element 21, for example in a region of the dielectric 24.

In the patch antenna 20 of an embodiment of the present disclosure, in plan view as illustrated in FIG. 17, in other word, when seen in the direction of the normal to the radiating element 21, the first feeding portion 26 is located on a first diagonal line 43 of the radiating element 21. The second feeding portion 27 is located on a second diagonal line 44 of the radiating element 21.

Here, the first feeding portion 26 being “located on the first diagonal line 43” refers to that the first diagonal line 43 intersects with at least a part of the first feeding portion 26. Further, the second feeding portion 27 being “located on the second diagonal line 44” refers to that the second diagonal line 44 intersects with at least a part of the second feeding portion 27.

The “first diagonal line 43” and the “second diagonal line 44” are diagonal lines of the radiating element 21 in a substantially quadrilateral shape as illustrated in FIG. 17. The center 40 of the patch antenna 20 is the center the radiating element 21 in the substantially quadrilateral shape. The radiating element 21 is in a substantially square shape as well, and thus the center 40 of the patch antenna 20 is the intersection of the first diagonal line 43 and the second diagonal line 44 as well.

The first diagonal line 43 and the second diagonal line 44 may be diagonal lines of the dielectric 24 in a substantially quadrilateral shape. In this case, the center 40 of the patch antenna 20 is the center of the dielectric 24 in the substantially quadrilateral shape.

In the patch antenna 20 of an embodiment of the present disclosure, as illustrated in FIG. 17, a distance DC1 between the center 40 and the first feeding portion 26 is substantially equal to a distance DC2 between the center 40 and the second feeding portion 27 (DC1=DC2). The distance DC1 between the center 40 and the first feeding portion 26 does not have to be equal to the distance DC2 between the center 40 and the second feeding portion 27.

In the patch antenna 20 of an embodiment of the present disclosure, the first feeding portion 26 is located closer to the corner 42 than to the center 40, on the first diagonal line 43. The second feeding portion 27 is located closer to the corner 42 than to the center 40, on the second diagonal line 44. However, the first feeding portion 26 or the second feeding portion 27 may be located closer to the center 40 than to the corner 42.

### Patch Antenna 20X of Comparative Example

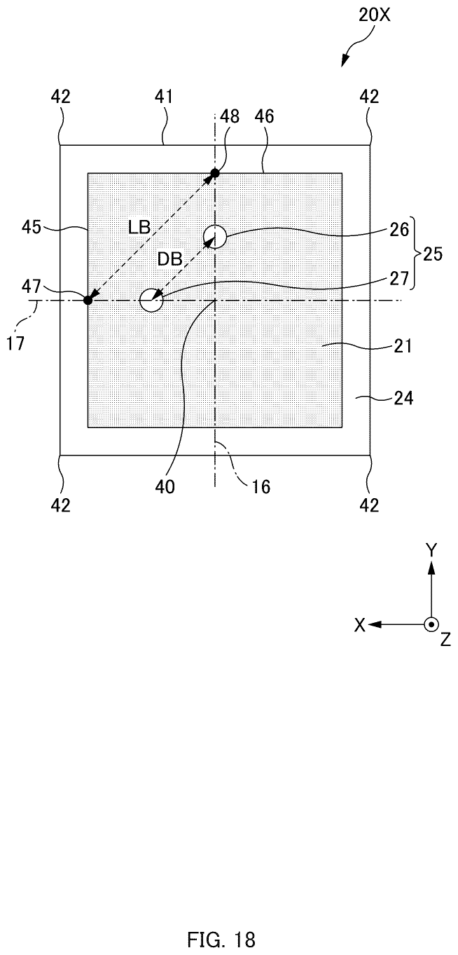

In the patch antenna 20 of an embodiment of the present disclosure, it is possible to easily ensure isolation between the first feeding portion 26 and the second feeding portion 27. This will be described with reference to a patch antennas 20X of a comparative example illustrated in FIG. 18.

FIG. 18 is a plan view of the patch antenna 20X according to the comparative example.

The patch antenna 20X of the comparative example includes the radiating element 21 and the dielectric 24 that are the same of similar to those of the patch antenna 20 of an embodiment of the present disclosure. In the patch antenna 20X, however, the first feeding portion 26 and the second feeding portion 27 are respectively located on a first axis 16 and a second axis 17 that are different from the first diagonal line 43 and the second diagonal line 44.

Here, the “first axis 16” is an axis that passes through the center 40 and that is parallel to a first side 45 of the radiating element 21 in the substantially quadrilateral shape. The “second axis 17” is an axis that passes through the center 40 and that is parallel to a second side 46 adjacent to the first side 45. The first axis 16 and the second axis 17 are axes orthogonal to each other.

In the patch antenna 20X of the comparative example, the first feeding portion 26 and the second feeding portion 27 are respectively located on the axes (the first axis 16 and the second axis 17) orthogonal to each other, resulting in the phase difference of 90 degrees in circularly polarized waves of the patch antenna 20X. However, there is a limit to the extent to which the patch antenna 20X have a distance DB between the two feeding portions (the first feeding portion 26 and the second feeding portion 27), which makes it difficult to ensure isolation between the two feeding portions.

In other words, as illustrated in FIG. 18, assuming that the center of the first side 45 is a first center 47 and the center of the second side 46 adjacent to the first side 45 is a second center 48, the distance DB between the two feeding portions (the first feeding portion 26 and the second feeding portion 27) has a maximum distance of a length LB of a straight line connecting the first center 47 and the second center 48.

In contrast, in the patch antenna 20 of an embodiment of the present disclosure, as illustrated in FIG. 17 described above, it is possible to increase a length DA of a straight line connecting the first feeding portion 26 and the second feeding portion 27 longer than the length LB of the straight line connecting the first center 47 and the second center 48 (i.e., the maximum value of the distance DB in the patch antenna 20X of the comparative example) in the radiating element 21 of the substantially quadrilateral shape. This makes it possible to provide a sufficient distance between the two feeding portions (the first feeding portion 26 and the second feeding portion 27), thereby being able to easily ensure isolation between the first feeding portion 26 and the second feeding portion 27.

### Patch Antenna 20A of Modification Example

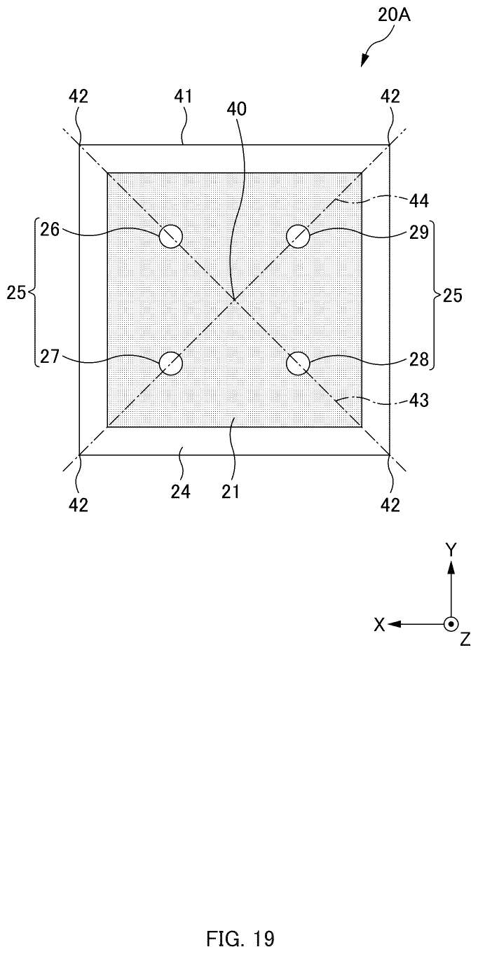

FIG. 19 is a plan view of a patch antenna 20A according to a modification example.

In the patch antenna 20A of the modification example, for example, a quadruple-feed system may be employed as illustrated in FIG. 19. The patch antenna 20A employing the quadruple-feed system includes four feeding portions 25. In other words, the patch antenna 20A further includes a third feeding portion 28 and a fourth feeding portion 29, in addition to the first feeding portion 26 and the second feeding portion 27. Here, the third feeding portion 28 is located on the first diagonal line 43, and the fourth feeding portion 29 is located on the second diagonal line 44.

In such a quadruple-feed system as well, it is possible to easily ensure isolation between a plurality (here, four) of feeding portions.

In the patch antenna 20A, as illustrated in FIG. 19, the first feeding portion 26 and the third feeding portion 28 are located at positions line symmetrical to each other with respect to the second diagonal line 44. The second feeding portion 27 and the fourth feeding portion 29 are located at positions line symmetrical to each other with respect to the first diagonal line 43. However, the first feeding portion 26 and the third feeding portion 28 do not have to be line-symmetrical to each other with respect to the second diagonal line 44, and the second feeding portion 27 and the fourth feeding portion 29 do not have to be line-symmetrical to each other with respect to the first diagonal line 43.

### Overview of Antenna Device 200

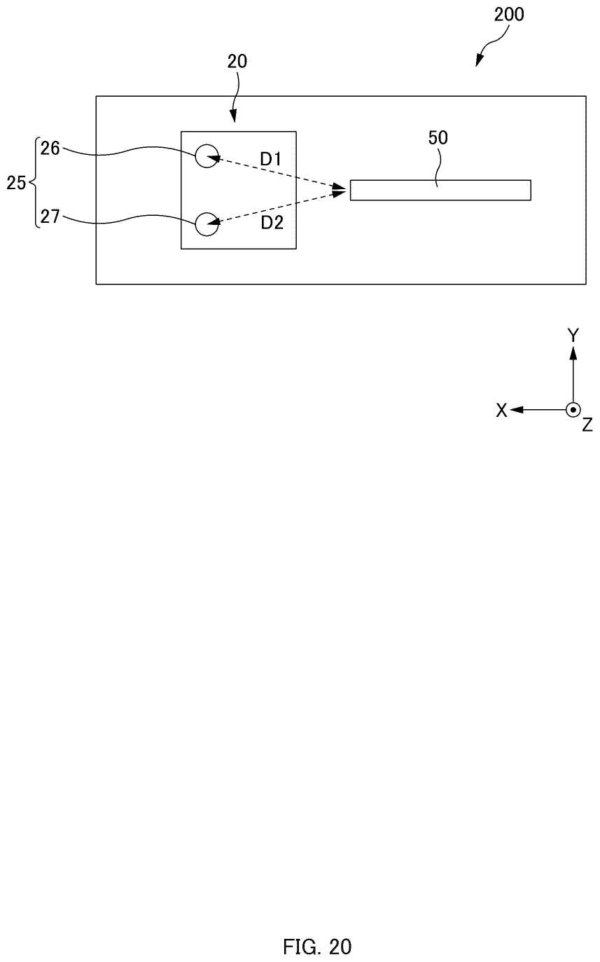

FIG. 20 is a plan view of an antenna device 200 according to the second embodiment.

The antenna device 200 includes the patch antenna 20 described above and another antenna 50 different from the patch antenna 20 as illustrated in FIG. 20. In this case, a first distance D1 between the first feeding portion 26 and the other antenna 50 is substantially equal to a second distance D2 between the second feeding portion 27 and the other antenna 50.

### Antenna Devices 200X and 200Y of Comparative Examples

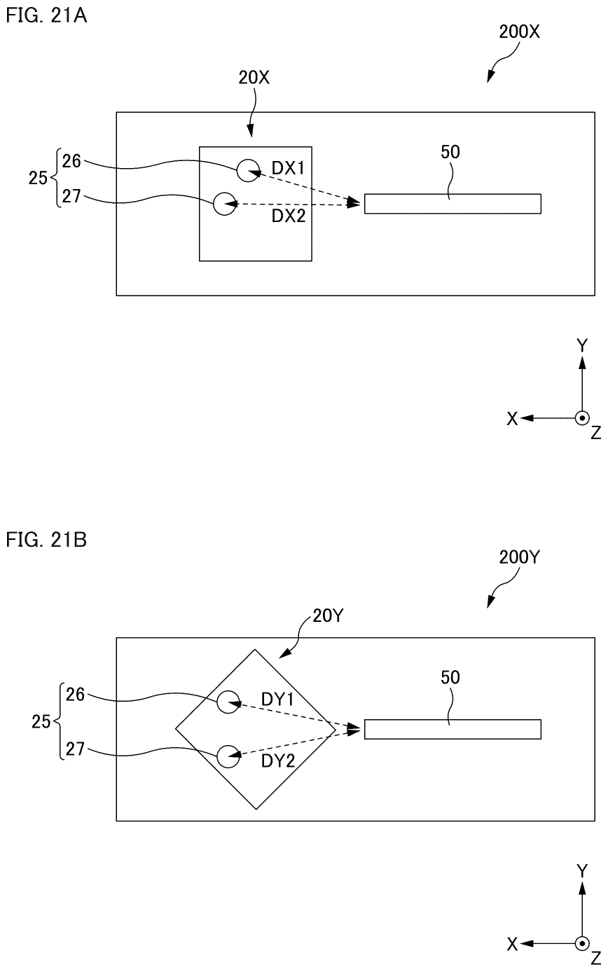

The antenna device 200 of an embodiment of the present disclosure described above can reduce the size of the antenna device 200, while suppressing influence on the characteristics of the patch antenna 20. This will be described with reference to an antenna device 200X of a first comparative example illustrated in FIG. 21A and an antenna device 200Y of a second comparative example illustrated in FIG. 21B.

FIG. 21A is a plan view of the antenna device 200X according to the first comparative example. FIG. 21B is a plan view of the antenna device 200Y according to the second comparative example.

The antenna device 200X includes the patch antenna 20X of the comparative example described above and another antenna 50 different from the patch antenna 20X. In this case, in the antenna device 200X, a first distance DX1 between the first feeding portion 26 and the other antenna 50 is different from a second distance DX2 between the second feeding portion 27 and the other antenna 50, as illustrated in FIG. 21A. Accordingly, the first feeding portion 26 and the second feeding portion 27 receive different degrees of electrical interference from the antenna 50, which affects the characteristics of the patch antenna 20X.

In contrast, the antenna device 200Y includes a patch antenna 20Y and another antenna 50 different from the patch antenna 20Y. Here, the patch antenna 20Y is a patch antenna obtained by rotating the patch antenna 20X by 90 degrees on the X-Y plane. This allows the antenna device 200Y to have a first distance DY1 between the first feeding portion 26 and the other antenna 50 substantially equal to a second distance DY2 between the second feeding portion 27 and the other antenna 50 as illustrated in FIG. 21B. However, this increases the size in the Y direction of the patch antenna 20Y rotated by 90 degrees to be larger than the size in the Y direction of the patch antenna 20X of the first comparative example.

In contrast, in the antenna device 200 of an embodiment of the present disclosure, as described above, the first distance D1 between the first feeding portion 26 and the other antenna 50 is substantially equal to the second distance D2 between the second feeding portion 27 and the other antenna 50. Furthermore, it is possible to reduce the size in the Y direction of the patch antenna 20. In other words, in the antenna device 200 of an embodiment of the present disclosure, it is possible to reduce the size of the antenna device 200, while suppressing influence on the characteristics of the patch antenna 20.

### Summary

According to the present description herein, a patch antenna in aspects describe below is provided.

### Aspect 1

An aspect 1 includes: the first feeding portion 26; the second feeding portion 27; and the radiating element 21 in a substantially quadrilateral shape, wherein when seen in the direction of the normal to the radiating element 21, the first feeding portion 26 is located on the first diagonal line 43 of the radiating element 21, and the second feeding portion 27 is located on the second diagonal line 44 of the radiating element 21.

According to an aspect described above, it is possible to easily ensure isolation between a plurality of feeding portions.

### Aspect 2

An aspect 2 includes: the first feeding portion 26; the second feeding portion 27; the dielectric 24 in a substantially quadrilateral shape; and the radiating element 21 arranged at the dielectric 24, wherein when seen in the direction of the normal to the radiating element 21, the first feeding portion 26 is located on the first diagonal line 43 of the dielectric 24, and the second feeding portion 27 is located on the second diagonal line 44 of the dielectric 24.

According to an aspect described above, it is possible to easily ensure isolation between a plurality of feeding portions.

### Aspect 3

In an aspect 3, the distance between the center 40 of the substantially quadrilateral shape and the first feeding portion 26 is substantially equal to the distance between the center 40 of the substantially quadrilateral shape and the second feeding portion 27.

According to an aspect described above, it is possible to easily ensure isolation between a plurality of feeding portions.

### Aspect 4

In an aspect 4, the first feeding portion 26 and the second feeding portion 27 are each located closer to the corner 42 of the substantially quadrilateral shape than to the center 40 of the substantially quadrilateral shape.

According to an aspect described above, it is possible to easily ensure isolation between a plurality of feeding portions.

### Aspect 5

In an aspect 5, assuming that the center of the first side 45 is the first center 47 and the center of the second side 46 adjacent to the first side 45 is the second center 48 in the substantially quadrilateral shape, the length DA of the straight line connecting the first feeding portion 26 and the second feeding portion 27 is longer than the length LB of the straight line connecting the first center 47 and the second center 48.

According to an aspect described above, it is possible to easily ensure isolation between a plurality of feeding portions.

### Aspect 6

An aspect 6 further includes: the third feeding portion 28; and the fourth feeding portion 29, wherein the third feeding portion 28 is located on the first diagonal line 43, and the fourth feeding portion 29 is located on the second diagonal line 44.

According to an aspect described above, it is possible to easily ensure isolation between a plurality of feeding portions.

### Aspect 7

In an aspect 7, the first feeding portion 26 and the third feeding portion 28 are line-symmetrical to each other with respect to the second diagonal line 44, and the second feeding portion 27 and the fourth feeding portion 29 are line-symmetrical to each other with respect to the first diagonal line 43.

According to an aspect described above, it is possible to easily ensure isolation between a plurality of feeding portions.

Further, according to the present description herein, an antenna device in aspects describe below is provided.

### Aspect 8

An aspect 8 includes: the patch antenna 20 described above; and another antenna 50 different from the patch antenna 20, wherein the first distance D1 between the first feeding portion 26 and the other antenna 50 is substantially equal to the second distance D2 between the second feeding portion 27 and the other antenna 50.

According to an aspect described above, it is possible to reduce the size of the antenna device, while suppressing influence on the characteristics of the patch antenna.

Embodiments described above are to simply facilitate understanding of the present disclosure, and are not in any way to be construed as limiting the present disclosure. The present disclosure may variously be changed and/or altered without departing from from its essential features and encompass equivalents thereof.

### REFERENCE SIGNS LIST

10, 10A to 10K, 10X to 10Z, 20, 20A, 20X, 20Y: Patch antenna;
11, 21: Radiating element;
12: First radiating element;
13: Second radiating element;
14, 24: Dielectric;
15, 25: Feeding portion;
26: First feeding portion;
27: Second feeding portion;
28: Third feeding portion;
29: Fourth feeding portion;
30: Slot region;
31 to 35: Cutout part;
40: Center;
42: Corner;
43: First diagonal line;
44: Second diagonal line;
45: First side;
46: Second side;
47: Center of first side (first center);
48: Center of second side (second center);
50: Antenna;
100, 200, 200X, 200Y: Antenna device.

1. A patch antenna comprising:
a first feeding portion;
a second feeding portion; and
a radiating element in a substantially quadrilateral shape, wherein
when seen in a direction of a normal to the radiating element,
the first feeding portion is located on a first diagonal line of the radiating element, and
the second feeding portion is located on a second diagonal line of the radiating element.

2. A patch antenna comprising:
a first feeding portion;
a second feeding portion;
a dielectric in a substantially quadrilateral shape; and
a radiating element arranged at the dielectric, wherein
when seen in a direction of a normal to the radiating element,
the first feeding portion is located on a first diagonal line of the dielectric, and
the second feeding portion is located on a second diagonal line of the dielectric.

3. The patch antenna according to claim 1, wherein a distance between a center of the substantially quadrilateral shape and the first feeding portion is substantially equal to a distance between the center of the substantially quadrilateral shape and the second feeding portion.

4. The patch antenna according to claim 1, wherein the first feeding portion and the second feeding portion are each located closer to a corner of the substantially quadrilateral shape than to a center of the substantially quadrilateral shape.

5. The patch antenna according to claim 1, wherein,
assuming that a center of a first side is a first center and a center of a second side adjacent to the first side is a second center in the substantially quadrilateral shape,
a length of a straight line connecting the first feeding portion and the second feeding portion is longer than a length of a straight line connecting the first center and the second center.

6. The patch antenna according to claim 1, further comprising:
a third feeding portion; and
a fourth feeding portion, wherein
the third feeding portion is located on the first diagonal line, and
the fourth feeding portion is located on the second diagonal line.

7. The patch antenna according to claim 6, wherein
the first feeding portion and the third feeding portion are line-symmetrical to each other with respect to the second diagonal line, and
the second feeding portion and the fourth feeding portion are line-symmetrical to each other with respect to the first diagonal line.

8. An antenna device comprising:
the patch antenna according to claim 1; and
another antenna different from the patch antenna, wherein
a first distance between the first feeding portion and the other antenna is substantially equal to a second distance between the second feeding portion and the other antenna.

9. The patch antenna according to claim 2, wherein a distance between a center of the substantially quadrilateral shape and the first feeding portion is substantially equal to a distance between the center of the substantially quadrilateral shape and the second feeding portion.

10. The patch antenna according to claim 2, wherein the first feeding portion and the second feeding portion are each located closer to a corner of the substantially quadrilateral shape than to a center of the substantially quadrilateral shape.

11. The patch antenna according to claim 2, wherein,
assuming that a center of a first side is a first center and a center of a second side adjacent to the first side is a second center in the substantially quadrilateral shape,
a length of a straight line connecting the first feeding portion and the second feeding portion is longer than a length of a straight line connecting the first center and the second center.

12. The patch antenna according to claim 2, further comprising:
a third feeding portion; and
a fourth feeding portion, wherein
the third feeding portion is located on the first diagonal line, and
the fourth feeding portion is located on the second diagonal line.

13. The patch antenna according to claim 12, wherein
the first feeding portion and the third feeding portion are line-symmetrical to each other with respect to the second diagonal line, and
the second feeding portion and the fourth feeding portion are line-symmetrical to each other with respect to the first diagonal line.

14. An antenna device comprising:
the patch antenna according to claim 2; and
another antenna different from the patch antenna, wherein
a first distance between the first feeding portion and the other antenna is substantially equal to a second distance between the second feeding portion and the other antenna.
